(19) United States
(12) Patent Application Publication
(10) Pub. No.: US 2024/0152841 A1
(43) Pub. Date: May 9, 2024

(54) Determination of Insights for Construction Projects Using Budget-Code Classification

(71) Applicant: Procore Technologies, Inc., Carpinteria, CA (US)

(72) Inventors: James Adam Pita, Middletown, MD (US); Catherine Knuff, Brooklyn, NY (US)

(21) Appl. No.: 17/981,388

(22) Filed: Nov. 5, 2022

(51) Int. Cl. G06Q 10/06; G06Q 10/10

(52) U.S. Cl. CPC G06Q 10/06375; G06Q 10/103

(57) ABSTRACT

A computing platform is configured to: obtain a set of data objects representing construction-project-related action items; evaluate the obtained set of data objects and thereby identify two or more budget-code-specific subsets of data objects, where each respective budget-code-specific subset of data objects corresponds to a respective one of two or more budget codes; for each respective one of the two or more budget codes, evaluate the respective budget-code-specific subset of data objects and thereby identify one or more budget-code-specific metrics for the respective one of the two or more budget codes; based at least on the identified budget-code-specific metrics for the two or more budget codes, determine one or more construction-related insights; and transmit, to a client station, data defining the one or more construction-related insights and thereby cause an indication of the one or more construction-related insights to be presented at a user interface of the client station.

### BACKGROUND

Construction projects are often complex endeavors involving the coordination of many professionals across several discrete phases. Typically, a construction project commences with a design phase, where architects design the overall shape and layout of a construction project, such as a building. Next, engineers engage in a planning phase where they take the architects' designs and produce engineering drawings and plans for the construction of the project. At this time, engineers may also design various portions of the project's infrastructure, such as HVAC, plumbing, electrical, etc., and produce plans reflecting these designs as well. After, or perhaps in conjunction with, the planning phase, contractors may engage in a logistics phase to review these plans and begin to allocate various resources to the project, including determining what materials to purchase, scheduling delivery, and developing a plan for carrying out the actual construction of the project. Finally, during the construction phase, construction professionals begin to construct the project based on the finalized plans.

Overview

Throughout a construction project, there may be project-related action items that arise on the construction project. In general, a project-related action item on a construction project may be any action related to an item, issue, or problem that is raised (e.g., by an individual associated with the construction project) during the construction project and that requires resolution. For instance, the action item may be an action to address an item, issue, or problem that is occurring or has occurred for the construction project, and the action item may be assigned to one or more individuals for resolution. Resolving action items may involve time and effort of one or more individuals involved with the construction project.

In practice, some action items may have a greater impact or potential impact on the construction project than other action items. For instance, some action items may have a greater budget impact or potential budget impact (e.g., higher cost) on the construction project than other action items. As another example, some action items may have a greater schedule impact or potential schedule impact (e.g., longer delay) on the construction project than other action items. Further, there may also be, for any given construction project, a large number of action items that arise and need to be resolved (which may be on the order of thousands, tens of thousands, hundreds of thousands, etc.).

It would be desirable to recognize impact(s) or potential impact(s) of action items on a construction project(s) before the action items occur or as the action items occur. Recognizing impact(s) or potential impact(s) of action items may help ensure that action items can be addressed within an appropriate time period and/or in an appropriate order for the construction project(s), which may in turn help avoid, reduce, or minimize budget and/or schedule impact associated with those action items. Further, recognizing impact(s) or potential impact(s) of action items may be beneficial when planning new or future construction projects and/or when addressing outstanding action items for an ongoing construction project.

One way to attempt to recognize impact(s) or potential impact(s) of action items on a construction project is by evaluating historical data about prior construction projects and prior action items associated with those prior construction projects. Historical data about prior construction projects may take various forms. In general, historical data may be any data created and stored throughout a construction project, such as data created and stored during a design phase, a planning phase, a logistics phase, and/or a construction phase of a construction project, among other possibilities. In some cases, historical data may include data objects related to the construction project that are created, stored, and accessed by users of a software as a service (“SaaS”) application for construction management. Of the data objects related to the construction project, a subset of the data objects may represent construction-project-related action items. Numerous types of data objects representing construction-project-related action items are possible, examples of which include “request for information” (“RFI”) data objects (e.g., data objects for the construction project related to requested information about given project tasks), “punch list” data objects (e.g., data objects that memorialize punch items on the construction project), and “observation” data objects (e.g., data objects for the construction project that memorialize observations made during on-site inspections of the construction project), among other possibilities.

However, attempting to derive insights related to action items associated with construction projects from historical data such as this can present numerous problems. For example, historical data may take the form of various different types of data objects (which may comprise a mix of structured and unstructured data) and the historical data may not be well organized. Such a mix of data and such organization may make it difficult to evaluate the historical data and derive insights related to action items associated with construction projects. Further, the data may be voluminous, which may also make it difficult to evaluate the historical data and derive insights related to action items associated with construction projects. In this regard, not only may there be a large number of completed or ongoing construction projects to be evaluated, but there may also be, for any given construction project, a large number of historical data objects representing construction-project-related action items (which may be on the order of thousands, tens of thousands, hundreds of thousands, millions, etc.). These factors (among others) make it difficult to extract meaningful insights regarding construction-related action items from such historical data.

To help address the aforementioned and other problems, disclosed herein is new software technology for evaluating data objects representing construction-project-related action items and determining construction-related insights. In practice, the disclosed software technology could be implemented in SaaS application for construction management, such as the SaaS application offered by Procore Technologies, Inc., but it should be understood that the disclosed technology for evaluation of data objects representing construction-project-related action items and determination of construction-related insights may be incorporated into various other types of software applications as well (including software applications in industries other than construction).

In accordance with the disclosed technology, a computing platform is configured to predict budget codes for data objects representing construction-project-related action items and then use those budget-code predictions as a basis for providing construction-related insights. The provided insights may be independent of any particular ongoing construction project and/or related to an ongoing construction project. The computing platform may predict budget codes for data objects representing construction-project-related action items and provide construction-related insights in various ways.

As one possibility, the computing platform may apply a classification model to data objects for some pool of historical construction projects to derive baseline metrics based on the budget code classifications and then use the metrics to provide insights about construction projects. As another possibility, the computing platform may first apply a classification model to data objects for some pool of historical construction projects to derive baseline metrics based on the budget-code classifications, and then thereafter apply the classification model to data objects for an ongoing construction project and use both the budget-code predictions and the previously-derived baseline metrics as a basis for providing insights about the ongoing construction project. As yet another possibility, the computing platform may apply a classification model to data objects for an ongoing construction project and then use the budget-code predictions as a basis for providing insights about the ongoing construction project. Other examples are possible as well.

The software technology disclosed herein may provide various benefits over existing techniques for recognizing impact(s) or potential impact(s) of action items to a construction project. For instance, predicting budget codes for construction-related data objects and then using those predictions as a basis for providing construction-related insights may provide a more efficient and accurate way to derive insights related to action items associated with construction projects compared to existing approaches for deriving insights related to action items associated with construction projects. Further, by organizing data objects representing construction-project-related action items based on budget code, the disclosed technology can derive and provide to users meaningful insights related to action items associated with construction projects that can be beneficial for planning new or future construction projects and/or addressing outstanding action items for an ongoing construction project.

In accordance with the above, in one aspect, disclosed herein is a method that involves a computing platform: (i) obtaining a set of data objects representing construction-project-related action items; (ii) evaluating the obtained set of data objects and thereby identifying two or more budget-code-specific subsets of data objects, where each respective budget-code-specific subset of data objects corresponds to a respective one of two or more budget codes; (iii) for each respective one of the two or more budget codes, evaluating the respective budget-code-specific subset of data objects and thereby identifying one or more budget-code-specific metrics for the respective one of the two or more budget codes; (iv) based at least on the identified budget-code-specific metrics for the two or more budget codes, determining one or more construction-related insights; and (v) transmitting, to a client station, data defining the one or more construction-related insights and thereby causing an indication of the one or more construction-related insights to be presented at a user interface of the client station.

In an example, the method further comprises selecting the set of data objects representing construction-project-related action items based on type of construction project.

In another aspect, disclosed herein is a computing system that includes at least one processor, a non-transitory computer-readable medium, and program instructions stored on the non-transitory computer-readable medium that are executable by the at least one processor to cause the computing platform to carry out the functions disclosed herein, including but not limited to the functions of the foregoing method.

For instance, in an example, a computing platform comprises: a network interface; at least one processor; a non-transitory computer-readable medium; and program instructions stored on the non-transitory computer-readable medium that are executable by the at least one processor such that the computing platform is configured to: obtain a set of data objects representing construction-project-related action items; evaluate the obtained set of data objects and thereby identify two or more budget-code-specific subsets of data objects, where each respective budget-code-specific subset of data objects corresponds to a respective one of two or more budget codes; for each respective one of the two or more budget codes, evaluate the respective budget-code-specific subset of data objects and thereby identify one or more budget-code-specific metrics for the respective one of the two or more budget codes; based at least on the identified budget-code-specific metrics for the two or more budget codes, determine one or more construction-related insights; and transmit, to a client station, data defining the one or more construction-related insights and thereby cause an indication of the one or more construction-related insights to be presented at a user interface of the client station.

In an example, the set of data objects representing construction-project-related action items is selected based on type of construction project.

In an example, the program instructions that are executable by the at least one processor such that the computing platform is configured to evaluate the obtained set of data objects and thereby identify two or more budget-code-specific subsets of data objects comprise program instructions that are executable by the at least one processor such that the computing platform is configured to: for each data object of the obtained set of data objects, use one or more machine learning models to output, for each respective one of the two or more budget codes, a predicted likelihood that the data object corresponds to the respective budget code; and based on the predicted likelihoods for the obtained set of data objects, identify two or more budget-code-specific subsets of data objects.

In an example, the one or more respective budget-code-specific metrics for the respective one of the two or more budget codes comprise one or more of: an expected amount of effort spent on an action item associated with the respective one of the two or more budget codes; an expected amount of time to close an action item associated with the respective one of the two or more budget codes; an expected timing when action items associated with the respective one of the two or more budget codes arise within a project timeline; an expected amount of budget impact of an action item associated with the respective one of the two or more budget codes; an expected amount of schedule impact of an action item associated with the respective one of the two or more budget codes; an expected likelihood of an action item associated with the respective one of the two or more budget codes maturing into a change event; and a typical quantity of action items associated with the respective one of the two or more budget codes that are outstanding at each of various different stages within a project timeline.

In an example, each of the one or more construction-related insights is independent of any particular ongoing construction project.

In an example, each of the one or more construction-related insights is related to an ongoing construction project.

In an example, the one or more construction-related insights comprise a prioritization of outstanding action items for the ongoing construction project.

In an example, the computing platform further comprises program instructions stored on the non-transitory computer-readable medium that are executable by the at least one processor such that the computing platform is configured to: obtain a second set of data objects, wherein each data object of the second set represents a respective outstanding action item for the ongoing construction project; evaluate the obtained second set of data objects and thereby identify two or more budget-code-specific subsets of data objects of the second set, where each respective budget-code-specific subset of data objects of the second set corresponds to a respective one of two or more budget codes, and wherein the program instructions that are executable by the at least one processor such that the computing platform is configured to, based at least on the identified budget-code-specific metrics for the two or more budget codes, determine one or more construction-related insights comprise program instructions that are executable by the at least one processor such that the computing platform is configured to: based at least on the identified budget-code-specific metrics and the two or more budget-code-specific subsets of data objects of the second set, determine a prioritization of outstanding action items for the ongoing construction project.

In an example, the computing platform further comprises program instructions stored on the non-transitory computer-readable medium that are executable by the at least one processor such that the computing platform is configured to: for each data object of the second set, evaluate the data object of the second set and thereby identify one or more project-related impact predictions related to the data object of the second set, and wherein the program instructions that are executable by the at least one processor such that the computing platform is configured to, based at least on the identified budget-code-specific metrics and the two or more budget-code-specific subsets of data objects of the second set, determine a prioritization of outstanding action items for the ongoing construction project comprise program instructions that are executable by the at least one processor such that the computing platform is configured to: based at least on the identified budget-code-specific metrics, the two or more budget-code-specific subsets of data objects of the second set, and the project-related impact predictions related to the data objects of the second set, determine the prioritization of outstanding action items for the ongoing construction project.

In an example, the one or more project-related impact predictions related to the data object of the second set comprise one or more of a predicted amount of budget impact for the data object, an amount of schedule impact for the data object, and a likelihood of a change event for the data object, and wherein the program instructions that are executable by the at least one processor such that the computing platform is configured to, for each data object of the second set, evaluate the data object of the second set and thereby identify one or more project-related impact predictions related to the data object of the second set comprise program instructions that are executable by the at least one processor such that the computing platform is configured to: for each data object of the second set, use one or more machine learning models to output, for the data object, the one or more of a predicted amount of budget impact for the data object, an amount of schedule impact for the data object, and a likelihood of a change event for the data object.

In an example, the one or more construction-related insights comprise an insight related to action items that do not currently exist for the ongoing construction project but are expected to arise.

In an example, each of the two or more budget codes is from a predefined group of potential budget codes.

In an example, the set of data objects representing construction-project-related action items comprises a plurality of types of data objects, wherein each type of data object comprises a given set of data fields that differs from the sets of data fields of other types of data objects.

In yet another aspect, disclosed herein is a non-transitory computer-readable medium comprising program instructions that are executable to cause a computing platform to carry out the functions disclosed herein, including but not limited to the functions of the foregoing method.

For instance, in an example, the non-transitory computer-readable medium, wherein the non-transitory computer-readable medium is provisioned with program instructions that, when executed by at least one processor, cause a computing platform to: obtain a set of data objects representing construction-project-related action items; evaluate the obtained set of data objects and thereby identify two or more budget-code-specific subsets of data objects, where each respective budget-code-specific subset of data objects corresponds to a respective one of two or more budget codes; for each respective one of the two or more budget codes, evaluate the respective budget-code-specific subset of data objects and thereby identify one or more budget-code-specific metrics for the respective one of the two or more budget codes; based at least on the identified budget-code-specific metrics for the two or more budget codes, determine one or more construction-related insights; and transmit, to a client station, data defining the one or more construction-related insights and thereby cause an indication of the one or more construction-related insights to be presented at a user interface of the client station.

In an example, the set of data objects representing construction-project-related action items is selected based on type of construction project.

In an example, the program instructions that, when executed by the at least one processor, cause the computing platform to evaluate the obtained set of data objects and thereby identify two or more budget-code-specific subsets of data objects comprise program instructions that, when executed by the at least one processor, cause the computing platform to: for each data object of the obtained set of data objects, use one or more machine learning models to output, for each respective one of the two or more budget codes, a predicted likelihood that the data object corresponds to the respective budget code; and based on the predicted likelihoods for the obtained set of data objects, identify two or more budget-code-specific subsets of data objects.

In an example, each of the one or more construction-related insights is independent of any particular ongoing construction project.

In an example, each of the one or more construction-related insights is related to an ongoing construction project.

In still yet another aspect, disclosed herein is a method that involves a computing platform: (i) obtaining a set of data objects representing construction-project-related action items; (ii) evaluating the obtained set of data objects and thereby identify two or more budget-code-specific subsets of data objects, where each respective budget-code-specific subset of data objects corresponds to a respective one of two or more budget codes; (iii) based at least on the two or more budget-code-specific subsets of data objects, determining one or more construction-related insights; and (iv) transmitting, to a client station, data defining the one or more construction-related insights and thereby causing an indication of the one or more construction-related insights to be presented at a user interface of the client station.

In an example, the set of data objects representing construction-project-related action items is a set of data objects representing outstanding action items for an ongoing construction project.

In still yet another aspect, disclosed herein is a computing system that includes at least one processor, a non-transitory computer-readable medium, and program instructions stored on the non-transitory computer-readable medium that are executable by the at least one processor to cause the computing platform to carry out the functions disclosed herein, including but not limited to the functions of the foregoing method.

For instance, in an example, a computing platform comprises: a network interface; at least one processor; a non-transitory computer-readable medium; and program instructions stored on the non-transitory computer-readable medium that are executable by the at least one processor such that the computing platform is configured to: obtain a set of data objects representing construction-project-related action items; evaluate the obtained set of data objects and thereby identify two or more budget-code-specific subsets of data objects, where each respective budget-code-specific subset of data objects corresponds to a respective one of two or more budget codes; based at least on the two or more budget-code-specific subsets of data objects, determine one or more construction-related insights; and transmit, to a client station, data defining the one or more construction-related insights and thereby cause an indication of the one or more construction-related insights to be presented at a user interface of the client station.

In an example, the program instructions that are executable by the at least one processor such that the computing platform is configured to evaluate the obtained set of data objects and thereby identify two or more budget-code-specific subsets of data objects comprise program instructions that are executable by the at least one processor such that the computing platform is configured to: for each data object of the obtained set of data objects, use one or more machine learning models to output, for each respective one of the two or more budget codes, a predicted likelihood that the data object corresponds to the respective budget code; and based on the predicted likelihoods for the obtained set of data objects, identify two or more budget-code-specific subsets of data objects.

In an example, the set of data objects representing construction-project-related action items is a set of data objects representing outstanding action items for an ongoing construction project.

In an example, the one or more construction-related insights comprises a prioritization of the outstanding action items for the ongoing construction project.

In an example, the computing platform further comprises program instructions stored on the non-transitory computer-readable medium that are executable by the at least one processor such that the computing platform is configured to: for each data object of the obtained set of data objects, evaluate the data object and thereby identify one or more project-related impact predictions related to the data object, and wherein the program instructions that are executable by the at least one processor such that the computing platform is configured to, based at least on the two or more budget-code-specific subsets of data objects, determine one or more construction-related insights comprise program instructions that are executable by the at least one processor such that the computing platform is configured to: based at least on the two or more budget-code-specific subsets of data objects and the project-related impact predictions related to the data objects, determine a prioritization of the outstanding action items for the ongoing construction project.

In an example, the one or more project-related impact predictions related to the data object comprise one or more of a predicted amount of budget impact for the data object, an amount of schedule impact for the data object, and a likelihood of a change event for the data object, and wherein the program instructions that are executable by the at least one processor such that the computing platform is configured to, for each data object of the obtained set of data objects, evaluate the data object and thereby identify one or more project-related impact predictions related to the data object of the obtained set of data objects comprise program instructions that are executable by the at least one processor such that the computing platform is configured to: for each data object of the obtained set of data objects, use one or more machine learning models to output, for the data object, the one or more of a predicted amount of budget impact for the data object, an amount of schedule impact for the data object, and a likelihood of a change event for the data object.

In an example, the computing platform further comprises program instructions stored on the non-transitory computer-readable medium that are executable by the at least one processor such that the computing platform is configured to: for each respective one of two or more budget codes, identify a respective amount of a construction budget of the ongoing construction project that is allocated to respective one of two or more budget codes, and wherein the program instructions that are executable by the at least one processor such that the computing platform is configured to, based at least on the two or more budget-code-specific subsets of data objects, determine one or more construction-related insights, comprise program instructions that are executable by the at least one processor such that the computing platform is configured to: based at least on the two or more budget-code-specific subsets of data objects and the identified respective amounts of the construction budget that are allocated to the budget codes, determine a prioritization of the outstanding action items for the ongoing construction project.

In an example, the computing platform further comprises program instructions stored on the non-transitory computer-readable medium that are executable by the at least one processor such that the computing platform is configured to: obtain a second set of data objects representing construction-project-related action items; evaluate the obtained second set of data objects and thereby identify two or more budget-code-specific subsets of data objects of the second set, where each respective budget-code-specific subset of data objects of the second set corresponds to a respective one of two or more budget codes; for each respective one of the two or more budget codes, evaluate the respective budget-code-specific subset of data objects of the second set and thereby identify one or more budget-code-specific metrics for the respective one of the two or more budget codes, and wherein the program instructions that are executable by the at least one processor such that the computing platform is configured to, based at least on the two or more budget-code-specific subsets of data objects, determine one or more construction-related insights, comprise program instructions that are executable by the at least one processor such that the computing platform is configured to: based at least on the two or more budget-code-specific subsets of data objects and the identified budget-code-specific metrics for the two or more budget codes, determine one or more construction-related insights.

In an example, the one or more respective budget-code-specific metrics for the respective one of the two or more budget codes comprise one or more of: an expected amount of effort spent on an action item associated with the respective one of the two or more budget codes; an expected amount of time to close an action item associated with the respective one of the two or more budget codes; an expected timing when action items associated with the respective one of the two or more budget codes arise within a project timeline; an expected amount of budget impact of an action item associated with the respective one of the two or more budget codes; an expected amount of schedule impact of an action item associated with the respective one of the two or more budget codes; an expected likelihood of an action item associated with the respective one of the two or more budget codes maturing into a change event; and a typical quantity of action items associated with the respective one of the two or more budget codes that are outstanding at each of various different stages within a project timeline.

In an example, each of the two or more budget codes is from a predefined group of potential budget codes.

In an example, the set of data objects representing construction-project-related action items comprises a plurality of types of data objects, wherein each type of data object comprises a given set of data fields that differs from the sets of data fields of other types of data objects.

In still yet another aspect, disclosed herein is a non-transitory computer-readable medium comprising program instructions that are executable to cause a computing platform to carry out the functions disclosed herein, including but not limited to the functions of the foregoing method.

For instance, in an example, the non-transitory computer-readable medium, wherein the non-transitory computer-readable medium is provisioned with program instructions that, when executed by at least one processor, cause a computing platform to: obtain a set of data objects representing construction-project-related action items; evaluate the obtained set of data objects and thereby identify two or more budget-code-specific subsets of data objects, where each respective budget-code-specific subset of data objects corresponds to a respective one of two or more budget codes; based at least on the two or more budget-code-specific subsets of data objects, determine one or more construction-related insights; and transmit, to a client station, data defining the one or more construction-related insights and thereby cause an indication of the one or more construction-related insights to be presented at a user interface of the client station.

In an example, the program instructions that, when executed by the at least one processor, cause the computing platform to evaluate the obtained set of data objects and thereby identify two or more budget-code-specific subsets of data objects comprise program instructions that, when executed by the at least one processor, cause the computing platform to: for each data object of the obtained set of data objects, use one or more machine learning models to output, for each respective one of the two or more budget codes, a predicted likelihood that the data object corresponds to the respective budget code; and based on the predicted likelihoods for the obtained set of data objects, identify two or more budget-code-specific subsets of data objects.

In an example, the set of data objects representing construction-project-related action items is a set of data objects representing outstanding action items for an ongoing construction project.

In an example, the one or more construction-related insights comprises a prioritization of the outstanding action items for the ongoing construction project.

In an example, the non-transitory computer-readable medium further comprises program instructions that, when executed by the at least one processor, cause the computing platform to: for each data object of the obtained set of data objects, evaluate the data object and thereby identify one or more project-related impact predictions related to the data object, and wherein the program instructions that, when executed by the at least one processor, cause the computing platform to, based at least on the two or more budget-code-specific subsets of data objects, determine one or more construction-related insights comprise program instructions that, when executed by the at least one processor, cause the computing platform to: based at least on the two or more budget-code-specific subsets of data objects and the project-related impact predictions related to the data objects, determine a prioritization of the outstanding action items for the ongoing construction project.

In an example, the one or more project-related impact predictions related to the data object comprise one or more of a predicted amount of budget impact for the data object, an amount of schedule impact for the data object, and a likelihood of a change event for the data object, and wherein the program instructions that, when executed by the at least one processor, cause the computing platform to, for each data object of the obtained set of data objects, evaluate the data object and thereby identify one or more project-related impact predictions related to the data object of the obtained set of data objects comprise program instructions that, when executed by the at least one processor, cause the computing platform to: for each data object of the obtained set of data objects, use one or more machine learning models to output, for the data object, the one or more of a predicted amount of budget impact for the data object, an amount of schedule impact for the data object, and a likelihood of a change event for the data object.

In an example, the non-transitory computer-readable medium further comprises program instructions that, when executed by the at least one processor, cause the computing platform to: for each respective one of two or more budget codes, identify a respective amount of a construction budget of the ongoing construction project that is allocated to respective one of two or more budget codes, and wherein the program instructions that, when executed by the at least one processor, cause the computing platform to, based at least on the two or more budget-code-specific subsets of data objects, determine one or more construction-related insights, comprise program instructions that, when executed by the at least one processor, cause the computing platform to: based at least on the two or more budget-code-specific subsets of data objects and the identified respective amounts of the construction budget that are allocated to the budget codes, determine a prioritization of the outstanding action items for the ongoing construction project.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts an example computing platform that may be configured to carry out one or more of the functions according to the disclosed technology.

FIG. 3 depicts an example process carried out by a computing platform prior to determining one or more construction-related insights according to the disclosed technology.

FIG. 4 depicts a conceptual illustration of an example data science model according to the disclosed technology.

FIG. 5A depicts an example process for identification of budget-code specific metrics according to the disclosed technology.

FIG. 5B depicts an example process for determination of one or more construction-related insights according to the disclosed technology.

FIG. 6 depicts an example process for determination of one or more construction-related insights according to the disclosed technology.

FIG. 7 depicts a conceptual illustration of an example data science model according to the disclosed technology.

FIG. 8 depicts a conceptual illustration of an example data science model according to the disclosed technology.

FIG. 9 depicts a conceptual illustration of an example data science model according to the disclosed technology.

FIG. 10 depicts an example snapshot of a graphical user interface (GUI) that may be presented to a user according to the disclosed technology.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, the present disclosure generally relates to technology for predicting budget codes for data objects representing construction-project-related action items and then using those predictions as a basis for providing construction-related insights. In practice, the disclosed technology may be incorporated into a software as a service (“SaaS”) application for managing construction projects, which may include back-end software that runs on a back-end computing platform and front-end software that runs on users' client stations (e.g., in the form of a native application, a web application, and/or a hybrid application, etc.) and can be used to access the SaaS application via a data network, such as the Internet. For example, as one possible example, the disclosed technology may be incorporated into a SaaS application for construction management, such as the one offered by Procore Technologies, Inc. However, other examples are possible as well.

### I. Example System Configuration

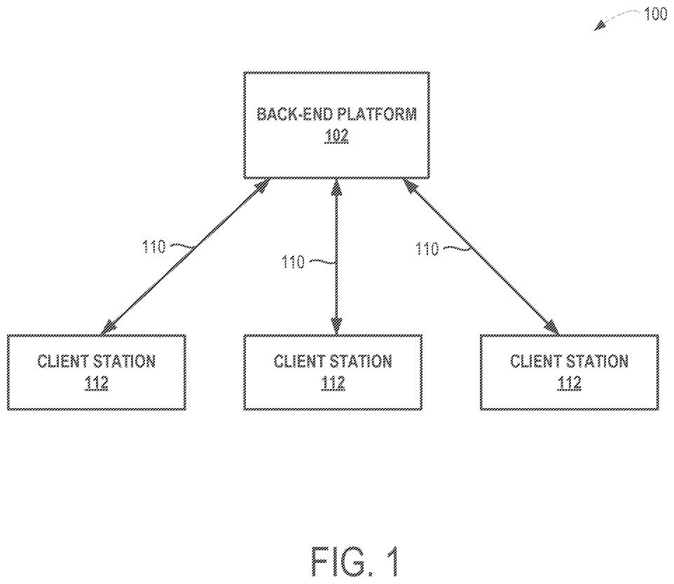

Turning now to the figures, FIG. 1 depicts an example network configuration 100 in which example embodiments of the present disclosure may be implemented. As shown in FIG. 1, network configuration 100 includes a back-end computing platform 102 that may be communicatively coupled to one or more client stations, depicted here, for the sake of discussion, as client stations 112.

Broadly speaking, back-end computing platform 102 may comprise one or more computing systems that have been installed with back-end software (e.g., program code) for hosting an example SaaS application that incorporates the disclosed technology and delivering it to users over a data network. The one or more computing systems of back-end computing platform 102 may take various forms and be arranged in various manners.

For instance, as one possibility, back-end computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like, which may be provisioned with software for carrying out one or more of the functions disclosed herein. As another possibility, back-end computing platform 102 may comprise “on-premises” computing resources of the organization that operates the example computing platform 102 (e.g., organization-owned servers), which may be provisioned with software for carrying out one or more of the functions disclosed herein. As yet another possibility, the example computing platform 102 may comprise a combination of cloud computing resources and on-premises computing resources. Other implementations of back-end computing platform 102 are possible as well.

In turn, client stations 112 may each be any computing device that is capable of accessing the SaaS application hosted by back-end computing platform 102. In this respect, client stations 112 may each include hardware components such as a processor, data storage, a communication interface, and user-interface components (or interfaces for connecting thereto), among other possible hardware components, as well as software components that facilitate the client station's ability to access the SaaS application hosted by back-end computing platform 102 and run the front-end software of the SaaS application (e.g., operating system software, web browser software, mobile applications, etc.). As representative examples, client stations 112 may each take the form of a desktop computer, a laptop, a netbook, a tablet, a smartphone, and/or a personal digital assistant (PDA), among other possibilities.

As further depicted in FIG. 1, back-end computing platform 102 may be configured to interact with client stations 112 over respective communication paths 110. In this respect, each communication path 110 between back-end computing platform 102 and one of client stations 112 may generally comprise one or more communication networks and/or communications links, which may take any of various forms. For instance, each respective communication path 110 with back-end computing platform 102 may include any one or more of point-to-point links, Personal Area Networks (PANs), Local-Area Networks (LANs), Wide-Area Networks (WANs) such as the Internet or cellular networks, and/or cloud networks, among other possibilities. Further, the communication networks and/or links that make up each respective communication path 110 with back-end computing platform 102 may be wireless, wired, or some combination thereof, and may carry data according to any of various different communication protocols. Although not shown, the respective communication paths 110 between client stations 112 and back-end computing platform 102 may also include one or more intermediate systems. For example, it is possible that back-end computing platform 102 may communicate with a given client station 112 via one or more intermediary systems, such as a host server (not shown). Many other configurations are also possible.

While FIG. 1 shows an arrangement in which three client stations are communicatively coupled to back-end computing platform 102, it should be understood that this is merely for purposes of illustration and that any number of client stations may communicate with back-end computing platform 102.

Although not shown in FIG. 1, back-end computing platform 102 may also be configured to interact with other third-party computing platforms, such as third-party computing platforms operated by organizations that have subscribed to the SaaS application and/or third-party computing platforms operated by organizations that provide back-end computing platform 102 with third-party data for use in the SaaS application. Such computing platforms, and the interaction between back-end computing platform 102 and such computing platforms, may take various forms.

It should be understood that network configuration 100 is one example of a network configuration in which embodiments described herein may be implemented. Numerous other arrangements are possible and contemplated herein. For instance, other network configurations may include additional components not pictured and/or more or fewer of the pictured components.

### II. Example Computing Platform

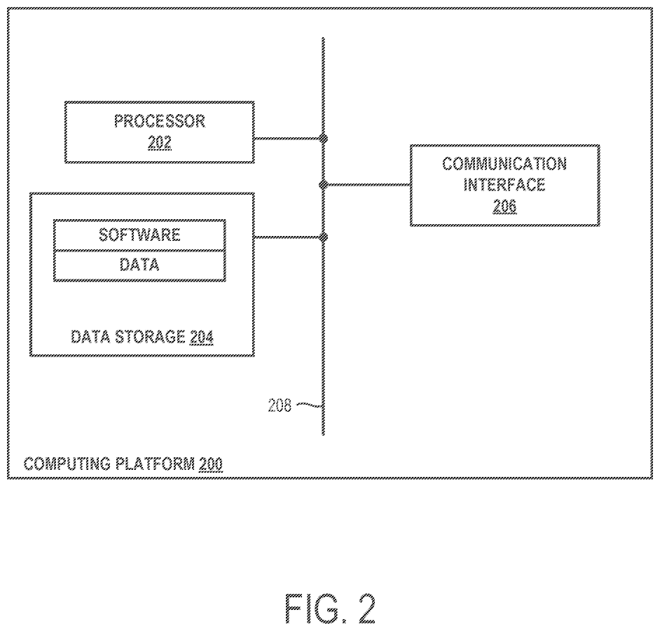

FIG. 2 is a simplified block diagram illustrating some structural components that may be included in an example computing platform 200, which could serve as, for instance, back-end computing platform 102 of FIG. 1. In line with the discussion above, computing platform 200 may generally comprise one or more computer systems (e.g., one or more servers), and these one or more computer systems may collectively include at least a processor 202, data storage 204, and a communication interface 206, all of which may be communicatively linked by a communication link 208 that may take the form of a system bus, a communication network such as a public, private, or hybrid cloud, or some other connection mechanism.

Processor 202 may comprise one or more processing components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 202 could comprise processing components that are distributed across a plurality of physical computing devices connected via a network, such as a computing cluster of a public, private, or hybrid cloud.

In turn, data storage 204 may comprise one or more non-transitory computer-readable storage mediums that are collectively configured to store (i) program instructions that are executable by processor 202 such that computing platform 200 is configured to perform some or all of the disclosed functions, which may be arranged together into engineering artifacts or the like, and (ii) data that may be received, derived, or otherwise stored by computing platform 200 in connection with the disclosed functions. In this respect, the one or more non-transitory computer-readable storage mediums of data storage 204 may take various forms, examples of which may include volatile storage mediums such as random-access memory, registers, cache, etc. and non-volatile storage mediums such as read-only memory, hard-disk drives, solid-state drives, flash memory, optical-storage devices, etc. Further, data storage 204 may utilize any of various types of data storage technologies to store data within the computing platform 200, examples of which may include relational databases, NoSQL databases (e.g., columnar databases, document databases, key-value databases, graph databases, etc.), file-based data stores (e.g., Hadoop Distributed File System or Amazon Elastic File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities. Further yet, in line with the discussion above, it should also be understood that data storage 204 may comprise computer-readable storage mediums that are distributed across a plurality of physical computing devices connected via a network, such as a storage cluster of a public, private, or hybrid cloud. Data storage 204 may take other forms and/or store data in other manners as well.

Communication interface 206 may be configured to facilitate wireless and/or wired communication with client stations (e.g., one or more client stations 112 of FIG. 1) and/or third-party computing platform. Additionally, in an implementation where computing platform 200 comprises a plurality of physical computing systems connected via a network, communication interface 206 may be configured to facilitate wireless and/or wired communication between these physical computing systems (e.g., between computing and storage clusters in a cloud network). As such, communication interface 206 may take any suitable form for carrying out these functions, examples of which may include an Ethernet interface, a serial bus interface (e.g., Firewire, USB 2.0, etc.), a chipset and antenna adapted to facilitate any of various types of wireless communication (e.g., WiFi communication, cellular communication, etc.), and/or any other interface that provides for wireless and/or wired communication. Communication interface 206 may also include multiple communication interfaces of different types. Other configurations are possible as well.

Although not shown, computing platform 200 may additionally include or have an interface for connecting to user-interface components that facilitate user interaction with computing system 200, such as a keyboard, a mouse, a trackpad, a display screen, a touch-sensitive interface, a stylus, a virtual-reality headset, and/or speakers, among other possibilities.

It should be understood that computing platform 200 is one example of a computing system that may be used with the embodiments described herein. Numerous other arrangements are possible and contemplated herein. For instance, other computing systems may include additional components not pictured and/or more or fewer of the pictured components.

### III. Example Operations

As mentioned above, the present disclosure generally relates to technology for predicting budget codes for data objects representing construction-project-related action items and then using those predictions as a basis for providing construction-related insights. As further mentioned above, the budget-code predictions and determination of construction-related insights described herein can be carried out by a back-end computing platform, such as back-end computing platform 102 of FIG. 1, that is hosting a SaaS application comprising front-end software running on users' client stations and back-end software running on the back-end computing platform that is accessible to the client stations via a data network, such as the Internet. For instance, the disclosed technology is described below in the context of a SaaS application for construction management, such as the SaaS application offered by Procore Technologies, Inc., but it should be understood that the disclosed technology may be utilized to determine construction-related insights based on budget-code classifications for projects in various other contexts as well.

i. Construction Project Data

In accordance with the disclosed technology, back-end computing platform 102 may be configured to facilitate management of a plurality of construction projects. In this regard, back-end computing platform 102 may create and store “construction project” data objects (or “project” data objects for short) that each represent a construction project workspace for a particular construction project in the real world. Each “project” data object may in turn be used to organize various types of other data objects related to the particular construction project. Data objects related to the particular construction project and associated with the “project” data object may generally comprise data that provides information about the particular construction project. Further, such data objects could take any of various different forms depending on the nature of the SaaS application.

For instance, a SaaS application for construction management may allow various different types of data objects related to the particular construction project to be created, stored, and accessed by users of the SaaS application. In practice, numerous types of data objects related to the particular construction project are possible, examples of which include “request for information” (“RFI”) data objects (e.g., data objects for the construction project related to requested information about given project tasks), “submittal” data objects (e.g., data objects for the construction project related to information provided by a responsible contractor (such as contractors and sub-contractors) to a general contractor), “incident” data objects (e.g., data objects for the construction project related to incidents (such as quality and/or safety incidents) that occurred during the construction project), “punch list” data objects (e.g., data objects that memorialize punch items on the construction project), “schedule” data objects (e.g., data objects that memorialize a schedule(s) related to the construction project), “inspection” data objects (e.g., data objects that memorialize an inspection(s) related to the construction project), “observation” data objects (e.g., data objects for the construction project that memorialize observations made during on-site inspections of the construction project), various types of financial-related data objects such as “budget” data objects (e.g., data objects that memorialize a budget item(s) related to the construction project), and/or “field productivity” data objects (e.g., data objects that memorialize items related to field productivity for the construction project, such items regarding time sheets and/or crews for the construction project). Other types of data objects are possible as well.

Within the SaaS application, each data-object type may represent data items of different types and thus data objects of different data-object types may be comprised of different sets of data fields compared to data objects of other data-object types. As an illustrative example of different sets of data fields, an “RFI” data object may include data fields of “RFI number,” “Subject,” “Status,” “Created By,” “Date Initiated,” “RFI Manager,” “Distribution List,” “Assignees,” “Due Date,” “Received From,” “Responsible Party,” “Drawing Number(s),” “Linked Drawing(s),” “Specification Section,” “Location,” “Schedule Impact,” “Cost Code,” “Cost Impact,” “Reference,” “Ball in Court,” “Question(s),” and/or “Response(s),” among other possibilities, whereas a “Observations” data object may include data fields of “Type,” “Trade,” “Title,” “Assignee,” “Assignee's Company,” “Date Modified,” “Due Date,” “Created By,” “Specification Section,” “Status,” “Priority,” “Location,” and/or “Comments,” among other possibilities. Other example sets of data fields are possible as well.

Further, in at least some examples, the SaaS application for construction management may provide various software features (also referred to as tools) that allow for creation and interaction with different types of data objects. For instance, such tools may include an “RFI” tool where a user may enter RFI data items for the construction project to request and/or provide information about given project tasks, a “submittals” tool where a user may enter submittal data items, an “incidents” tool where a user may enter incident data items related to incidents (such as quality and/or safety incidents) that occurred during the construction project, a “punch list” tool where a user may enter punch list items, an “inspection” tool where a user may enter inspection items, an “observations” tool where a user may enter observation data items for the construction project that memorialize observations made during on-site inspections of the construction project, various types of financial tools such as a “budget” tool where a user may enter construction-budget items, and/or a “field productivity” tool where a user may enter field-productivity items. Other tools are possible as well. Further, in some examples, a given tool may allow a user to create, store, access, and/or modify a plurality of different types of data objects.

Of the data objects related to the particular construction project, there may be a subset of data objects that represent project-related action items. In general, a project-related action item may be any action or task related to an item, issue, or problem that is raised (e.g., by an individual associated with the construction project) during the construction project and that requires or involves resolution. For instance, the action item may be an action or task to address an item, issue, or problem that is occurring or has occurred for the construction project. Further, a data object for a project-related action item may be any data object representing an outstanding issue/item on a construction project that requires someone to review and resolve the action item. In an example, when the action item is resolved, the data object may be updated (e.g., in response to receiving user-input indicating that the action item is resolved) to reflect that the action item is closed. In an example, the subset of data objects that represent project-related action items includes various types of data objects. For instance, in an example, the subset of data objects includes “RFI” data objects, “punch list” data objects, and “observation” data objects, among other possibilities.

The stored data objects that are associated with the “project” data objects and that represent project-related action items may be used by back-end computing platform 102 to drive various functionality for classification of data objects representing project-related action items by budget code and determination of construction-related insights using budget-code classification, as described in further detail below.

ii. Model-Creation Phase

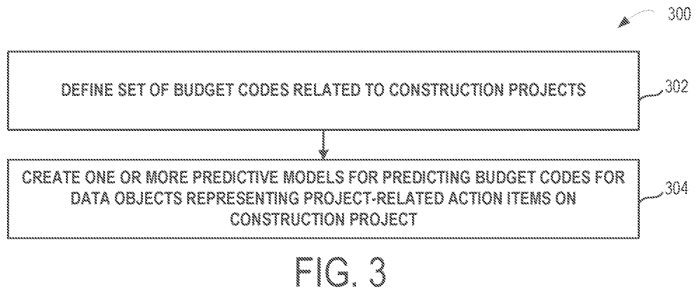

As noted above, the disclosed technology for determining construction-related insights uses budget-code classifications to determine the construction-related insights. Prior to utilizing the disclosed technology, there will generally be a model-creation phase where the budget codes are established and the predictive models for predicting budget codes for data objects representing project-related action items are created. FIG. 3 is one example of such a model-creation phase that may be carried out in accordance with the disclosed technology prior to determining construction-related insights. For purposes of illustration only, example process 300 is described as being carried out by back-end computing platform 102 of FIG. 1, but it should be understood that example process 300 may be carried out by computing platforms that take other forms as well. Further, it should be understood that, in practice, the functions described with reference to FIG. 3 may be encoded in the form of program instructions that are executable by one or more processors of back-end computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

The example process 300 may begin at block 302, where back-end computing platform 102 defines a set of budget codes related to construction projects. For instance, back-end computing platform 102 may define a universe of budget codes related to construction projects and this universe of budget codes may be used by the predictive models for predicting budget codes for data objects representing project-related action items (e.g., the budget codes in the universe may be available for assignment to data objects).

The universe of available budget codes related to construction projects may include any suitable construction-related budget codes. In an example, the universe of available budget codes to be used for the analysis of data objects may include a site-construction budget code, a concrete budget code, a masonry budget code, a metals budget code, a wood-and-plastics budget code, a thermal-and-moisture-protection budget code, a doors-and-windows budget code, a finishes budget code, a specialties budget code, an equipment budget code, a furnishings budget code, a special-construction budget code, a conveying systems budget code, a mechanical budget code, a mark-up and contingency budget code, and an electrical budget code. Further, in some examples, one or more of the aforementioned budget codes may be divided into a plurality of budget codes that provide more granularity. For instance, as one possibility, rather than a single budget code of “electrical,” the universe of budget codes may include a plurality of budget codes related to electrical, such as a basic-electrical-materials-and-methods budget code, an electrical-power budget code, a transmission-and-distribution budget code, a low-voltage-distribution budget code, a lighting budget code, a communications budget code, and a sound-and-video budget code, among other possibilities. Along similar lines, in some examples, each of the single budget codes of a site-construction budget code, a concrete budget code, a masonry budget code, a metals budget code, a wood-and-plastics budget code, a thermal-and-moisture-protection budget code, a doors-and-windows budget code, a finishes budget code, a specialties budget code, an equipment budget code, a furnishings budget code, a special-construction budget code, a conveying systems budget code, a mechanical budget code, and/or a mark-up and contingency budget code may be divided into a plurality of budget codes that provide more granularity. Additional and/or alternative budget codes in the universe of available budget codes are possible as well.

In practice, the particular universe of budget codes that are available for assignment to data objects (e.g., by the predictive models) could be defined by the SaaS application provider, the users of the SaaS application, or some combination thereof. Further yet, the particular universe of budget codes that are available for assignment to data objects could vary based on factors such as the type of SaaS application and/or the type of projects being evaluated, among other possibilities.

Returning to FIG. 3, at block 304, back-end computing platform 102 may create one or more predictive models for predicting budget codes for data objects representing project-related action items on a construction project. In general, each respective predictive model for predicting budget codes may include (i) pre-processing logic that derives feature data for a data object, (ii) a trained machine learning model that is configured to receive feature data for a data object and then output scores for different budget-code options, and (iii) post-processing logic that evaluates the scores and then determines which budget code or budget codes to predict/assign for the data object.

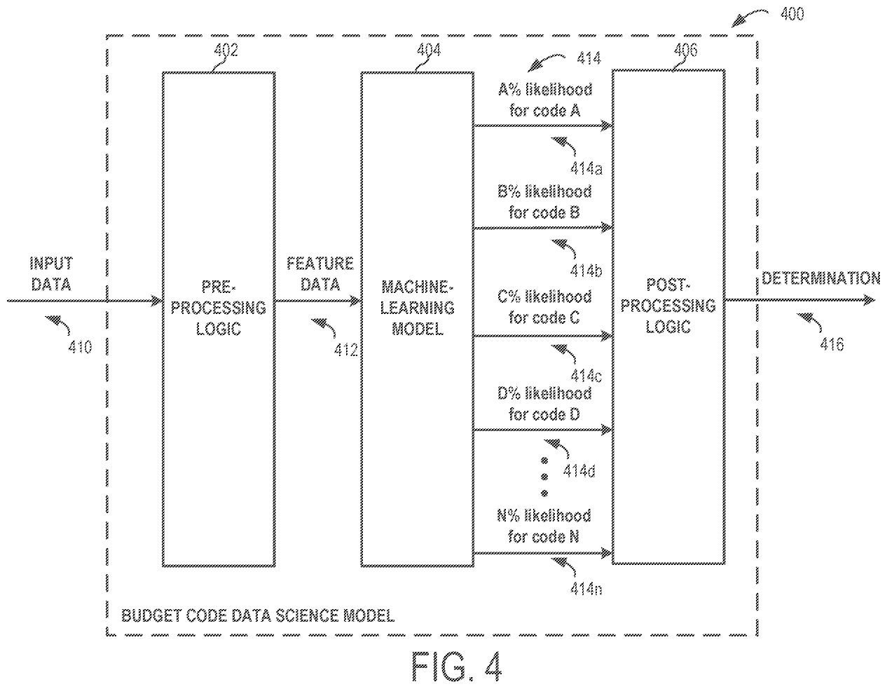

FIG. 4 depicts a conceptual illustration of one example of a data science model 400 for determining which budget code or budget codes to predict or assign for the data object in accordance with the present disclosure. As shown in FIG. 4, data science model 400 may comprise pre-processing logic 402, a machine-learning model 404, and post-processing logic 406. At a high level, pre-processing logic 402 may function to (i) receive input data 410 for a given data object that represents a given project-related action item and (ii) transform input data 410 for the given data object into feature data 412 for the given data object, which is then provided as input to machine-learning model 404. In turn, machine-learning model 404 may comprise any trained model object that is configured to (i) receive feature data 412 for the given data object as input, (ii) evaluate feature data 412 for the given data object, and (iii) based on the evaluation of the feature data, determine and output predictions 414 that each take the form of predicted likelihood that the data object corresponds to a respective budget code. In turn, post-processing logic 406 (e.g., a likelihood-percentage threshold) may function to evaluate predictions 414 and then determine which budget code or budget codes to predict or assign for the data object. These aspects of data science model 400 will now be described in greater detail.

To begin, input data 410 for the given data object that is input into data science model 400 may generally comprise any data that may be utilized to produce feature data 412 for the given data object. Such input data 410 could take any of various forms. In an example, for a given data object, input data 410 includes all of the data values associated with the data object. In another example, input data 410 includes a subset of the data values associated with the data object. For instance, in practice, certain data values associated with the data object (e.g., data values in certain data fields) may have more influence or weight (compared to other data values) with respect to determining which budget code(s) may correspond to the data object, in which case data science model 400 may be configured to receive only a subset of the data values for a data object. As an illustrative example using an “RFI” data object having the data fields discussed above, rather than input data 410 including all of the data values for each data field of an “RFI” data object, input data 410 may include a subset of the data values for the “RFI” data object, such as the data values for the data fields of “Subject,” “RFI Manager,” “Assignees,” “Received From,” “Responsible Party,” “Specification Section,” “Location,” “Cost Code,” “Cost Impact,” “Question(s),” and “Response(s).” Other examples are possible as well.

As noted above, input data 410 for the given data object may be received by pre-processing logic 402 of data science model 400, which may function to transform input data 410 into feature data 412 for the given data object, which is then input into machine-learning model 404. In this respect, feature data 412 for the given data that is produced by pre-processing logic 402 and input into machine-learning model 404 may generally comprise data for any feature variables that may facilitate budget-code prediction for the given data object. This feature data 412—and pre-processing logic 402 that produces feature data 412—may take any of various forms.

As one possibility, pre-processing may take the form of Natural Language Processing (“NLP”) techniques that analyze data values associated with the data object and translate input data 410 into feature data 412 having an appropriate form for input into machine-learning model 404. Such NLP techniques may include, as some nonlimiting examples, identifying and extracting keywords and/or key features from the raw text included in user-input data, correcting any spelling and/or grammatical errors, unification, non-ascii character removal, stop word removal, lemmatization, and sentiment analysis. As an illustrative example, using an “RFI” data object having the data fields discussed above, back-end computing platform 102 may pre-process data values associated with the “Question(s)” and “Response(s)” data fields, so as to translate those data values into feature data to be input into machine-learning model 404. For instance, the pre-processing may involve looking for words and/or phrases potentially indicative of a budget code (e.g., concrete, masonry, metal, wood, plastic, thermal protection, moisture protection, door, window, finish, furnish, convey, electric, plumbing, etc.) in the “Question(s)” and “Response(s)” data fields (as such language may be indicative of a budget code). This matching may include a fuzziness component that looks for synonyms or near-match phrases. Feature data 412 may then be derived based on the NLP processing.

As another possibility, there may be one or more additional machine learning models as part of pre-processing logic 402. For instance, in an example, the pre-processing may involve using a pre-trained topic model, such as a Bidirectional Encoder Representations from Transformers (BERT) topic model (e.g., BERTopic model), to extract out topics that may then be used as features to machine learning model 404. Other examples of pre-processing and/or feature data are possible as well.

In line with the discussion above, machine-learning model 404 may then comprise any trained model object that is configured to (i) receive feature data 412 for the given data object as input, (ii) evaluate feature data 412 for the given data object, and (iii) based on the evaluation of the feature data, determine and output predictions 414 that each take the form of predicted likelihood that the data object corresponds to a respective budget code. For instance, as shown in FIG. 4, data science model 400 may be a multi-class classification model that may output (1) a first prediction 414a that takes the form of a predicted likelihood that the data object corresponds to a first budget code A (e.g., site-construction budget code), which is shown in FIG. 4 as A %, (2) a second prediction 414b that takes the form of a predicted likelihood that the data object corresponds to a second budget code B (e.g., concrete budget code), which is shown in FIG. 4 as B %, (3) a third prediction 414c that takes the form of a predicted likelihood that the data object corresponds to a third budget code C (e.g., masonry budget code), which is shown in FIG. 4 as C %, (4) a fourth prediction 414d that takes the form of a predicted likelihood that the data object corresponds to a fourth budget code D (e.g., metals budget code), which is shown in FIG. 4 as D %, and so forth through (N) an Nth prediction 414n that takes the form of a predicted likelihood that the data object corresponds to an Nth budget code N (e.g., electrical budget code), which is shown in FIG. 4 as N %. However, predictions 414 output by multi-class classification model 404 may take other forms as well.

In practice, machine-learning model 404 of data science model 400 may be produced by applying a machine-learning process to historical feature data for a pool of historical data objects, where such a machine-learning process may involve any of various types of machine-learning techniques, examples of which may include a neural network technique (which is sometimes referred to as “deep learning”), a regression technique, a k-Nearest Neighbor (kNN) technique, a decision-tree technique, a support vector machines (SVM) technique, a Bayesian technique, an ensemble technique, a clustering technique, an association-rule-learning technique, a dimensionality reduction technique, an optimization technique such as gradient descent, a regularization technique, and/or a reinforcement technique, among other possible types of machine learning techniques.

In turn, post-processing logic 406 (e.g., a likelihood-percentage threshold) may function to evaluate predictions 414 and then determine which budget code(s) to predict or assign for the data object. In particular, after predictions 414 are output by machine-learning model 404, the predictions may be input into post-processing logic 406 that functions to evaluate predictions 414 in order to reach determination 416 as to which budget code(s), if any, to assign for the data object. This post-processing logic 406 may take various forms.

As one possibility, post-processing logic 406 may function to identify the one given budget code for which the data object that has the highest predicted likelihood of correspondence and then determine that the data object corresponds to that one given budget code. For instance, in an example where A % likelihood is a 75% likelihood, B % likelihood is a 45% likelihood, C % likelihood is a 35% likelihood, D % likelihood is a 25% likelihood, and N % likelihood is a 5% likelihood, such post-processing logic 406 may function to determine that the data object corresponds to budget code A.

As another possibility, post-processing logic 406 may function to identify any budget code(s) for which the data object has a predicted likelihood of correspondence that satisfies a threshold value and then determine that the data object corresponds to each identified budget code (if any). The threshold value may be any suitable threshold, such as any threshold percentage likelihood of at least 50%. With reference to FIG. 4, in an example where A % likelihood is a 75% likelihood, B % likelihood is a 65% likelihood, C % likelihood is a 35% likelihood, D % likelihood is a 25% likelihood, N % likelihood is a 5% likelihood, and an example threshold value of 60% is used, such post-processing logic 406 may function to determine that the data object corresponds to both budget code A and budget code B.

As yet another possibility, post-processing logic 406 may function to identify the one given budget code for which the data object has the highest predicted likelihood of correspondence and then either (i) determine that the data object corresponds to the one given budget code if the predicted likelihood satisfies a threshold value, or (ii) determine that the data object does not correspond to any budget code if the predicted likelihood does not satisfy the threshold value. With reference to FIG. 4, in an example where A % likelihood is a 75% likelihood, B % likelihood is a 45% likelihood, C % likelihood is a 35% likelihood, D % likelihood is a 25% likelihood, and N % likelihood is a 5% likelihood, and an example threshold value of 70% is used, such post-processing logic 406 may determine that the data object corresponds to budget code A. On the other hand, in an example where A % likelihood is a 75% likelihood, B % likelihood is a 45% likelihood, C % likelihood is a 35% likelihood, D % likelihood is a 25% likelihood, and N % likelihood is a 5% likelihood, and an example threshold value of 80% is used, such post-processing logic 406 may function to determine that the data object does not correspond to any particular budget code. Other examples of post-processing logic 406 for machine-learning model 404 are possible as well.

While FIG. 4 shows one possible example of a data science model for predicting the budget codes to which data objects correspond that may be created and deployed in accordance with the present disclosure, it should be understood that data science model 400 could take other forms as well.

As one possibility, while FIG. 4 shows a single machine learning model that takes the form of a multi-class classification model, instead of a multi-class classification model, data science model 400 may comprise a plurality of binary classification models that are each configured to (i) receive feature data 412 for a data object, evaluate feature data 412, and then based on the evaluation, output a prediction that takes the form of predicted likelihood that the data object corresponds to one respective budget code from the predefined group of budget codes. For instance, instead of the multi-class classification model 404 of FIG. 4, data science model 400 may comprise (1) a first binary classification model that is configured to output a first prediction 414a that takes the form of a predicted likelihood that the data object corresponds to a first budget code A (e.g., site-construction budget code), (2) a second binary classification model that is configured to output a second prediction 414b that takes the form of a predicted likelihood that the data object corresponds to a second budget code B (e.g., concrete budget code), (3) a third binary classification model that is configured to output a third prediction 414c that takes the form of a predicted likelihood that the data object corresponds to a third budget code C (e.g., masonry budget code), (4) a fourth binary classification model that is configured to output a fourth prediction 414d that takes the form of a predicted likelihood that the data object corresponds to a fourth budget code D (e.g., metals budget code), and so forth through (N) an Nth binary classification model that is configured to output an Nth prediction 414n that takes the form of a predicted likelihood that the data object corresponds to an Nth budget code N (e.g., electrical budget code). In such an implementation, post-processing logic 406 may then function to evaluate the individual predictions in order to reach determination 416 as to which budget code(s), if any, to assign for the data object.

As another possibility, other multiclass binary classification approaches are possible. For instance, in an example, the classification may take the form of a one-vs-all binary classification system. For instance, in an illustrative example where the budget codes include budget code A through budget code N, data science model 400 may comprise (1) a first one-vs-all binary classification system configured to determine whether a data object is more likely to correspond to budget code A or another code of the remainder of the N codes, (2) a second one-vs-all binary classification system configured to determine whether a data object is more likely to correspond to budget code B or another code of the remainder of the N codes, (3) a third one-vs-all binary classification system configured to determine whether a data object is more likely to correspond to budget code C or another code of the remainder of the N codes, and so forth through (N) an Nth one-vs-all binary classification system configured to determine whether a data object is more likely to correspond to budget code N or another code of the remainder of the N codes. This approach may turn binary classification methods into multi-classification. In another example, the classification may take the form of a one-vs-one binary classification system. For instance, in an illustrative example, data science model 400 may comprise a first one-vs-one binary classification system configured to determine whether a data object is more likely to correspond to budget code A or budget code B, a second one-vs-one binary classification system configured to determine whether a data object is more likely to correspond to budget code A or budget code C, a third one-vs-one binary classification system configured to determine whether a data object is more likely to correspond to budget code A or budget code D, and so forth. This approach may turn binary classification methods into multi-classification. Other examples are possible as well.

As yet another possibility, while FIG. 4 shows an example where post-processing logic 406 is encoded within data science model 400 itself, it should be understood that in other examples, post-processing logic 406 could be encoded separately from data science model 400 itself. As still yet another possibility, while FIG. 4 shows an example where pre-processing logic 402 is encoded within data science model 400 itself, it should be understood that in other examples, at least some of pre-processing logic 402 could be encoded separately from the data science model. The disclosed data science model 400 could take other forms as well.

Returning to block 304 of FIG. 3, the one or more predictive models for predicting budget codes for data objects representing project-related action items on a construction project may be created in various ways. As a representative example, one possible example of an example of a process that may be carried out in order to create the one or more predictive models, such as data science model 400, in accordance with the present disclosure is described. The example process may begin with back-end computing platform 102 identifying a pool of historical data objects to use during the creation of the one or more predictive models. In this respect, back-end computing platform 102 may identify a set of data objects for use in creating the one or more predictive models. The set of data objects for use in creating one or more predictive models may include data objects from the subset of data objects that represent project-related action items, and back-end computing platform 102 may identify any suitable set of data objects. Additionally, in a scenario where machine-learning model 404 of data science model 400 is to be trained using a supervised machine learning process, then back-end computing platform 102 may focus its identification on historical data objects associated with “ground truth” data that provides a sufficiently-accurate indication of budget code for the data object. In this respect, the back-end computing platform's identification of the pool of historical data objects may involve an evaluation of the availability of ground truth data for the historical data objects and perhaps also an evaluation of the reliability of available ground truth data for the historical data objects (e.g., by performing some validation of the ground truth data based on other data associated with the historical data object), among other possibilities. The function of identifying the pool of historical data objects to use during the creation of data science model 400 may take other forms as well.

After identifying the pool of historical data objects, back-end computing platform 102 may next obtain an initial (or “source”) dataset for the identified pool of historical data objects that is to be used to create data science model 400. This initial dataset may generally comprise for each historical data object in the identified pool, a respective set of initial data that may be utilized to produce feature data for the historical data object that is to be used to train machine learning model 404 during the machine learning process. In this respect, the respective set of initial data that is obtained for each historical data object in the identified pool may include any of the various types of input data described above with reference to input data 410 of FIG. 4. The initial dataset that is obtained for the identified pool of historical data objects may take other forms as well.

In the example process, back-end computing platform 102 may next apply pre-processing logic to the initial dataset for the identified pool of historical data objects in order to transform the initial dataset into one or more feature datasets, each of which may comprise respective sets of feature data for certain historical data objects in the identified pool. In this respect, the respective set of feature data that is derived for a historical data object in the identified pool may generally comprise data for some initial universe of feature variables that could potentially provide insight into the budget code(s) to which a data object may correspond. The feature variables in this initial universe may take any of various forms, including but not limited to any of the types of feature variables described above with reference to feature data 412 of FIG. 4. Additionally, in a scenario where machine-learning model 404 of data science model 400 is to be trained using a supervised machine learning process, then back-end computing platform 102 may also associate the respective set of feature data for each historical transaction with “ground truth” data that provides an indication of the budget code for the data object.

In the example process, back-end computing platform 102 may carry out a machine-learning process based on the one or more feature datasets in order to produce a machine-learning model that is configured to (i) receive, as input, feature data for a given data object, (ii) evaluate the given set of feature data for the given data object, and (iii) based on the evaluation of the given set of feature data, determine and output scores for different budget-code options. This machine-learning process may involve the use of any of various types of machine-learning techniques for training such a machine-learning model, examples of which may include a neural network technique (which is sometimes referred to as “deep learning”), a regression technique, a k-Nearest Neighbor (kNN) technique, a decision-tree technique, a support vector machines (SVM) technique, a Bayesian technique, an ensemble technique, a clustering technique, an association-rule-learning technique, a dimensionality reduction technique, an optimization technique such as gradient descent, a regularization technique, and/or a reinforcement technique, among various other techniques, and may take any of various forms.

After machine-learning model 404 has been produced by the machine-learning process, that machine-learning model may be packaged up together with pre-processing logic 404 for producing the model's input features and post-processing logic 406 and may then be deployed as data science model 400.

The process for creating the one or more predictive models in accordance with the present disclosure may take other forms as well. Further, the example process for creating the one or more predictive models is described as being carried out by the back-end computing platform 102 shown FIGS. 1-2, but it should be understood that the example process may be carried out by any computing platform that is capable of performing the described functions. Further, it should be understood that, in practice, the functions described with reference to the example process may be encoded in the form of program instructions that are executable by one or more processors of the back-end computing platform 102. Further yet, it should be understood that the example process for creating the one or more predictive models is merely described in this manner for the sake of clarity and explanation and that the example process for creating the one or more predictive models may be implemented in various other manners, including the possibility that functions may be added, removed, rearranged into different orders, combined, and/or separated depending upon the particular embodiment.

As discussed above, back-end computing platform 102 may create one or more predictive models for predicting budget codes for data objects representing project-related action items on a construction project. The one or more predictive models may include a plurality of created models. In some examples, the data science model used for a first data-object type (or a first set of data-object types) may be different than the data science model used for a second data-object type (or a second set of data-object types), and so on. For instance, the data science model used for the first data-object type may comprise a first machine learning model (or a first set of machine learning models) that is trained using historical data objects of the first data-object type (which may have a first set of data fields), whereas the data science model used for the second data-object type may comprise a second machine learning model (or a second set of machine learning models) that is trained using historical data objects of the second data-object type (which may have a second set of data fields that differs from the first set), and so on. Along similar lines, the pre-processing logic that is included and/or associated with a data science model may be different for different data-object types (e.g., a first set of pre-processing logic for a first data-object type, a second set of pre-processing logic for a second data-object type, and so on). Other examples are possible as well.

Further, in some examples, the SaaS application may give users the ability to assign user-assigned budget or cost codes to data objects when the data objects are created and/or modified (e.g., when “RFI” data objects, “punch list” data objects, and/or “observation” data objects are created and/or modified based on user input). In examples where data objects representing construction-project-related action items have such user-assigned budget or cost codes, the user-assigned budget or cost codes may optionally be utilized by back-end computing platform 102. Back-end computing platform 102 may be configured to utilize such user-assigned budget or cost codes in various ways.

As one possibility, back-end computing platform 102 may use such user-assigned budget or cost codes as input data for data science model 400. In an example, a user-assigned budget or cost code may be assigned a given weight that influences the predictions output by machine learning model 404. As another possibility, back-end computing platform 102 may perform an initial check or rule for each data object being analyzed and use the user-assigned budget or cost code (rather than predicting with machine learning model 404) if available. For instance, if there is a user-assigned budget or cost code associated with the data object (and the user-assigned budget or cost code associated is in the universe of budget codes available for assignment by the predictive models), then back-end computing platform 102 may not predict budget code with machine learning model 404 and instead treat the associated budget or cost code as the identified budget code. In yet other examples, even if such a user-assigned budget or cost code exists for a data object, back-end computing platform 102 may ignore the user-assigned budget or cost code and independently predict the budget code(s) for the data object using data science model 400. Such independent prediction may provide data-driven reflection of budget code(s) for the data objects, which may beneficially be a more accurate reflection of the budget code(s) associated with the data object representing the construction-project-related action item than a user-driven assignment of budget code for the data object. In an example, some data objects may be assigned by a user a single budget code; however, predicting the budget code(s) for the data object using data science model 400 may identify not only the assigned single budget code but also one or more further budget codes corresponding to the data object. This assignment of multiple budget codes to a single data object may enhance or improve the historical metrics (which are described in greater detail in following subsections) that may be derived based on budget-code specific subsets of data objects, as well as enhance or improve construction-related insights (which are described in greater detail in following subsections) that may be derived based on budget-code specific subsets of data objects and/or the historical metrics. Other examples of utilizing such user-assigned budget or cost codes are possible as well.

In practice, in examples where the SaaS application gives users the ability to assign user-assigned budget or cost codes to data objects when the data objects are created and/or modified, the budget or cost codes available to be assigned by a user may be customizable. For instance, for a given project, the SaaS application may allow a user to define a customized set of budget codes available to be assigned by a user for that given project. Thus, different projects may each have different sets of budget codes that are available for assignment by users. On the other hand, the universe of budget codes available for assignment by the predictive models may have standardized budget codes (which may facilitate creating metrics against historical data from projects that may have the different, customized budget or cost codes). While user-assigned budget or cost codes may be useful and optionally taken into account by the predictive models, the predictive models may predict one or more of the standardized budget codes from the universe of budget codes available for assignment by the predictive models.

iii. Model-Execution Phase

After creating the one or more predictive models, back-end computing platform 102 may use these predictive model(s) and the determined budget-code classifications output by the predictive model(s) to determine one or more construction-related insights. At a high level, the model-execution phase may include both “historical project analysis” phase and an “insights” phase. The “historical project analysis” phase may involve applying the data science model(s) for predicting budget codes to a given set of historical data objects and then using the budget-code predictions and other data related to the historical data objects to derive various per-budget-code metrics. Further, the “insights” phase may involve using the per-budget-code metrics and/or the data science model(s) to provide construction-related insights to users. The construction-related insights may be independent of any particular ongoing construction project and/or related to an ongoing construction project. These phases will now be described in greater detail.

A. Historical Project Analysis Phase

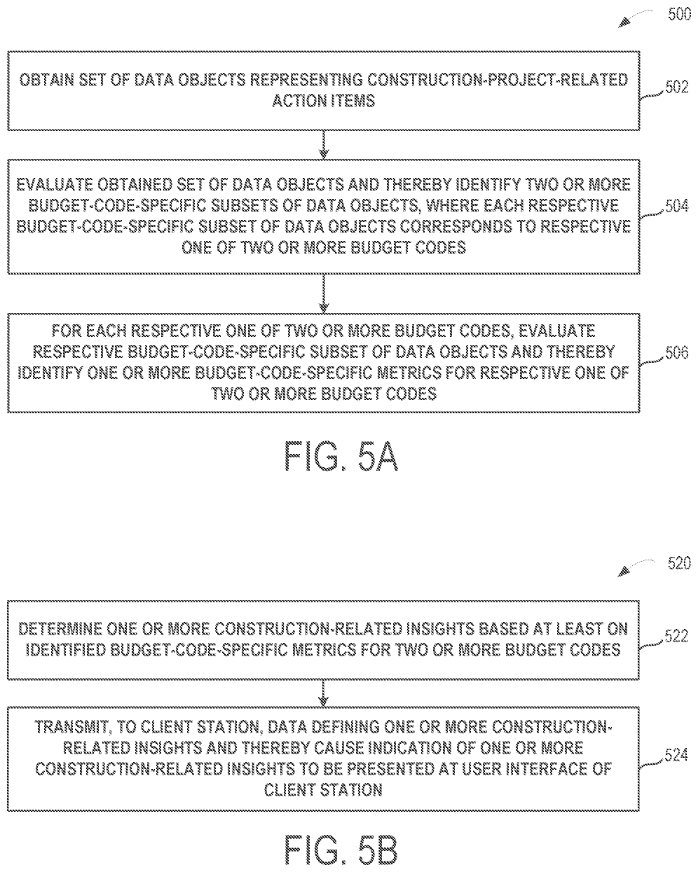

FIG. 5A depicts one example of a process 500 that may be carried out in accordance with the disclosed technology for identifying budget-code specific metrics, which may be used to facilitate determination of one or more construction-related insights. For purposes of illustration only, example process 500 is described as being carried out by back-end computing platform 102 of FIG. 1, but it should be understood that example process 500 may be carried out by computing platforms that take other forms as well. Further, it should be understood that, in practice, the functions described with reference to FIG. 5A may be encoded in the form of program instructions that are executable by one or more processors of back-end computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

1. Obtain Data Objects Representing Construction-Project-Related Action Items

The example process 500 may begin at block 502, where back-end computing platform 102 obtains a set of data objects representing construction-project-related action items. As described above, back-end computing platform 102 may store a plurality of data objects for each of the construction projects of the SaaS application. Further, the plurality of data objects for each of the construction projects may include a plurality of different types of data objects, some of which represent construction-project-related action items.

Back-end computing platform 102 may obtain the set of data objects representing construction-project-related action items in various ways. For instance, in an example, back-end computing platform 102 may obtain the set of data objects representing construction-project-related action items by accessing the data objects from data storage 204. In general, the set of data objects may include data objects from each respective construction project in a pool of construction projects. Further, for each respective construction project in the pool of construction projects, the obtained set of data objects may be any appropriate set of data objects representing construction-project-related action items and from which budget-code-specific metrics may be determined. As one possibility, the set of data objects related to the respective construction project may include all or a portion of the data objects from each respective type of data object in the universe of types of data objects representing construction-project-related action items. For instance, in an example where the universe of types of data objects representing construction-project-related action items includes “RFI” data objects, “punch list” data objects, and “observation” data objects, the set of obtained data objects representing construction-project-related action items may include all or a portion of the data objects from each of those types. As another possibility, the set of data objects representing construction-project-related action items may include all or a portion of the data objects from each respective type of data object in a subset of data objects from the universe of data objects representing construction-project-related action items.

The pool of construction projects from which the set of data objects is obtained may vary. As one possibility, the pool of construction projects includes each completed or ongoing construction project that is available in the SaaS application. As another possibility, the pool of construction projects includes a subset of completed or ongoing construction projects that are available in the SaaS application. Other examples are possible as well.

In some examples, the set of data objects representing construction-project-related action items and to be evaluated is selected based on type of construction project. In an example, construction-project type may be defined in various ways, including, for instance, by project-category(ies), organization(s), project duration(s), overall project budget(s), and/or project geography(ies), among other possibilities. By selecting the set of data objects representing construction-project-related action items and to be evaluated based on type of construction project, the one or more insights that are determined based on the determined budget-code specific metrics may be geared towards a desired type of construction project. As an illustrative example, in a scenario where construction-related insights are desired for a particular category of construction project (e.g., school construction projects), the set of data objects representing construction-project-related action items may be selected based on that particular category of construction project. In turn, the derived budget-code specific metrics (and the insights which are based on the budget-code specific metrics) may be geared toward the particular category of construction project (e.g., school construction projects).

As another illustrative example, in a scenario where construction-related insights are desired for construction projects for a given organization or set of organizations (e.g., a first organization or set of organizations), the set of data objects representing construction-project-related action items may be selected based on that first organization or set of organizations. In turn, the derived budget-code specific metrics (and the insights which are based on the budget-code specific metrics) may be geared toward the given organization or set of organizations (e.g., a first organization or set of organizations).

As yet another illustrative example, in a scenario where construction-related insights are desired for construction projects having a duration within a given project duration range (e.g., a first project duration range, such as 6 months to a year (although other durations are possible as well including, for instance, less than 6 months, 1-2 years, or greater than 3 years, among other possibilities), the set of data objects representing construction-project-related action items may be selected based on that given project duration range. In turn, the derived budget-code specific metrics (and the insights which are based on the budget-code specific metrics) may be geared toward the given project duration range (e.g., a first project duration range).

As still yet another illustrative example, in a scenario where construction-related insights are desired for construction projects having an overall construction budget within a given project budget range (e.g., a first project budget range, such as 1-2 million USD (although other budget ranges are possible as well including, for instance, less than 1 million USD, 2-5 million USD, or greater than 5 million USD, among other possibilities), the set of data objects representing construction-project-related action items may be selected based on that given project budget range. In turn, the derived budget-code specific metrics (and the insights which are based on the budget-code specific metrics) may be geared toward the given project budget range (e.g., a first project budget range).

As still yet another illustrative example, in a scenario where construction-related insights are desired for construction projects having a given project geography (e.g., a first project geography, such as a year-round warm climate location rather than a four-season climate location), the set of data objects representing construction-project-related action items may be selected based on that given project geography. In turn, the derived budget-code specific metrics (and the insights which are based on the budget-code specific metrics) may be geared toward the given project geography (e.g., year-round warm climate locations). Other examples are possible as well.

2. Budget-Code Classification of Data Objects

At block 504, back-end computing platform 102 evaluates the obtained set of data objects and thereby identifies two or more budget-code-specific subsets of data objects, where each respective budget-code-specific subset of data objects corresponds to a respective one of two or more budget codes.

In an example, evaluating the obtained set of data objects representing construction-project-related action items and thereby identifying the two or more budget-code-specific subsets of data objects involves evaluating the obtained set of data objects representing construction-project-related action items in order to identify, for each respective budget code in a predefined group of potential budget codes, a respective subset of data objects from the obtained set of data objects that correspond to the respective budget code. The predefined group of potential construction-related budget codes may include each budget code in the universe of available budget codes or a subset of budget codes from the universe of available budget codes. As an illustrative example, in line with the discussion above where the universe of budget codes includes N budget codes, the predefined group of potential construction-related budget codes may include each of the N budget codes. Further, in such an example where the predefined group of potential construction-related budget codes includes N budget codes, back-end computing platform 102 may identify (1) a first subset of data objects having data objects that each correspond to a first budget code A (e.g., site-construction budget code), (2) a second subset of data objects having data objects that each correspond to a second budget code B (e.g., concrete budget code), (3) a third subset set of data objects having data objects that each correspond to a third budget code C (e.g., masonry budget code), (4) a fourth subset set of data objects having data objects that each correspond to a fourth budget code D (e.g., metals budget code), and so forth through (N) an Nth subset set of data objects having data objects that each correspond to an Nth budget code N (e.g., electrical budget code). Further, in some examples, a given data object may correspond to multiple budget codes, and thus the given data object may be included in two or more of the N subsets. Still further, it should be understood that there may be an additional subset of data objects comprising data objects that are not identified as corresponding to any of the N budget codes.

The function of identifying the two or more budget-code-specific subsets of data objects may take various forms. In at least some implementations, back-end computing platform 102 may utilize one or more data analytics operations that serve to analyze data objects in the set of data objects representing construction-project-related action items in order to determine or predict the budget code(s) to which the obtained data objects correspond. Such a data analytics operation may be performed on an object-by-object basis and may take various forms.

As one possibility, the data analytics carried out by back-end computing platform 102 to determine the budget code(s) to which the obtained data objects correspond may be embodied in the form of one or more data science models, such as the one or more created predictive models discussed above (e.g., data science model 400), that are each configured to determine, on an object-by-object basis, the budget code(s) to which a data object correspond.

As another possibility, the data analytics carried out by back-end computing platform 102 to determine the budget code(s) to which the obtained data objects correspond may be embodied in the form of a user-defined set of rules that is applied to the obtained data objects (and more particularly, to each data object's data values) in order to determine, on an object-by-object basis, the budget code(s) to which a data object corresponds. In general, any suitable rule(s) to determine which budget code(s) to which a data object corresponds may be utilized. As an illustrative example, using an “RFI” data object, a rule may be that if the “RFI” data object has a “cost code” value that corresponds to one of the predefined budget codes, that “RFI” data object is associated with that predefined budget code. Other examples are possible as well.

As mentioned above, there may be a plurality of types of data objects representing construction-project-related action items. In some examples, the specific data analytics utilized to determine the budget code(s) to which a data object corresponds may vary for different types of data objects. As one possibility, the data analytics carried out for a first data-object type (or a first set of data-object types) may be different than the data analytics carried out for a second data-object type (or a second set of data-object types). For instance, the data analytics carried out for a first data-object type (or a first set of data-object types) may take the form of a user-defined set of rules, whereas the data analytics carried out for a second data-object type (or a second set of data-object types) may take the form of a data science model.

As another possibility, in situations where the data analytics carried out take the form of a data science model such as data science model 400, the data science model used for a first data-object type (or a first set of data-object types) may be different than the data science model used for a second data-object type (or a second set of data-object types), and so on. For instance, the data science model used for the first data-object type may comprise a first machine learning model (or a first set of machine learning models) that is trained using historical data objects of the first data-object type (which may have a first set of data fields), whereas the data science model used for the second data-object type may comprise a second machine learning model (or a second set of machine learning models) that is trained using historical data objects of the second data-object type (which may have a second set of data fields that differs from the first set), and so on. Along similar lines, the pre-processing logic that is included and/or associated with a data science model may be different for different data-object types (e.g., a first set of pre-processing logic for a first data-object type, a second set of pre-processing logic for a second data-object type, and so on). Other examples are possible as well.

As indicated above, back-end computing platform 102 may perform an evaluation of each data object in the obtained set of data representing construction-project-related action items in order to determine the budget code(s) (if any) to which the data object corresponds. In turn, back-end computing platform 102 may utilize these object-by-object budget-code determinations as a basis for identifying, for each respective budget code, the respective budget-code-specific subsets of data objects (from the obtained set of data objects) that correspond to the respective budget code. For instance, as one possibility, back-end computing platform 102 may update the respective subsets of data objects for the budget codes on an object-by-object basis as each data object is evaluated, by adding each evaluated data object to the respective subset for the budget code to which the data object is determined to correspond. As another possibility, back-end computing platform 102 may assign a respective budget code “label” to each data object that is evaluated to indicate the budget code(s) to which the data object is determined to correspond, and then after all of the obtained data objects are evaluated, back-end computing platform 102 may build the respective budget-code-specific subsets of data objects for the budget codes based on the assigned budget-code labels. Other examples are possible as well.

3. Identification of Historical Budget-Code-Specific Metrics

After identifying the two or more budget-code-specific subsets of data objects for the historical data objects, back-end computing platform 102 may then evaluate the budget-code-specific subsets of data objects and thereby identify budget-code-specific metrics. In particular, after identifying the two or more budget-code-specific subsets of data objects, then at block 506, for each respective one of the two or more budget codes, back-end computing platform 102 may evaluate the respective budget-code-specific subset of data objects and thereby identify one or more budget-code-specific metrics for the respective one of the two or more budget codes.

In general, these historical, per-budget-code-specific metrics may be any suitable metric that can be used for determining one or more insights related to construction projects. Various per-budget-code metrics are possible.

As one possibility, a per-budget-code metric for a given budget code may take the form of a typical or expected amount of effort (e.g., time) spent on an action item associated with that given budget code. In this regard, back-end computing platform 102 may, for each budget code, identify the typical or expected amount of effort (e.g., time) spent on an action item. In an example, the amount of effort spent on an action item may correspond to an amount of time spent by one or more individuals to resolve the action item.

In some examples, a typical or expected amount of effort spent on an action item for a given budget code could be represented at a project level. For instance, for a given budget code, back-end-computing platform 102 may determine (i) for a first project (or a first set of projects) of the pool of projects, a first typical or expected amount of effort spent on an action item for the given budget code, (ii) for a second project (or a second set of projects) of the pool of projects, a second typical or expected amount of effort spent on an action item for the given budget code, and so forth. In other examples, a typical or expected amount of effort spent on an action item could be represented at a per-action-item level. For instance, for a given budget code, back-end-computing platform 102 may determine an average amount of effort spent per action item for the action items associated with the given budget code.

As another possibility, a per-budget-code metric for a given budget code may take the form of a metric that reflects how the typical or expected amount of time/effort spent on action items for the given budget code during the course of a project compares to the typical or expected amount of project budget allocated for the given budget code. In this regard, back-end computing platform 102 may, for each budget code, compute a typical or expected amount of project budget that is allocated for the budget code and then derive a metric that reflects how the typical or expected amount of effort spent on action items for the budget code during the course of a project compares to the determined typical or expected amount of project budget allocated for the budget code. In some examples, the per-budget-code metric that reflects how the typical or expected amount of effort spent on action items for the budget code during the course of a project compares to the determined typical or expected amount of project budget allocated for the budget code may be a monetary amount (e.g., dollar) per time amount (e.g., per minute) metric. For instance, as an illustrative example, for a given example budget code, the typical amount of effort may be 10 minutes per action item, there may typically be 10 action items in a given project, and there may typically be a budget of $100 for this budget code. In this illustrative example, this means that typically $1/minute is spent on these action items. As another illustrative example, for a given example budget code, the typical amount of effort may be 10 minutes per action item, there may typically be 10 action items in a given project, and there may typically be a budget of $1,000 for this budget code. In this illustrative example, this means that typically $10/minute is spent on these action items.

As another possibility, a per-budget-code metric for a given budget code may take the form of a typical or expected amount of time to close an action item associated with that given budget code. In this regard, back-end computing platform 102 may, for each budget code, identify the typical or expected amount of time to close an action item. In an example, a data object representing a construction-project-related action item may include a “Status” field and closing the action item may involve updating (e.g., in response to receiving user input) the status of the action item to resolved or closed (e.g., the status may be updated from “Open” to “Closed). In an example, the amount of time to close an action item may be determined by calculating the time difference between when the action item originated and when the action item was closed. Furthermore, similar to the example discussed above related to a typical or expected amount of effort spent on an action item, a typical or expected amount of time to close an action item could be represented at a project level or at a per-action-item level.

As another possibility, a per-budget-code metric for a given budget code may take the form of a typical or expected timing when action items associated with that given budget code arise within a project timeline. In this regard, back-end computing platform 102 may, for each budget code, identify the typical or expected timing when action items arise within the project timeline. In some examples, identifying the typical or expected timing may involve identifying the point or stage within a project's timeline the action item typically occurs. The different points or stages within the project's timeline may be defined in various ways. As one possibility, the different points or stages within the project's timeline may be defined based on a predefined percentage of completion of the construction-related activity for the construction projects (e.g., 25%, 50%, 75%, and/or 100% complete), among other possibilities. Furthermore, similar to the example discussed above related to a typical or expected amount of effort spent on an action item, typical or expected timing when action items arise within project timeline could be represented at a project level or at a per-action-item level.

As another possibility, a per-budget-code metric for a given budget code may take the form of a typical or expected amount of budget impact. In this regard, back-end computing platform 102 may, for each budget code, identify the typical or expected amount of budget impact of an action item. Budget impact may be a change to a construction project's budget. In an example, the typical or expected amount of budget impact may be derived based on historical data showing linkage between data objects and change orders. In general, a change order is a written record of a contract modification that details any amendment(s) to the original agreement's scope of work. In practice, construction contracts are typically executed with a clearly defined scope of work, so any work that is added, substituted, or deleted from the original contract's scope (such as changes to a project's designs, conditions, schedules, and/or costs) will typically require an approved change order. Furthermore, similar to the example discussed above related to a typical or expected amount of effort spent on an action item, a typical or expected amount of budget impact could be represented at a project level or at a per-action-item level.

As another possibility, a per-budget-code metric for a given budget code may take the form of a typical or expected amount of schedule impact. In this regard, back-end computing platform 102 may, for each budget code, identify the typical or expected amount of schedule impact of an action item. Schedule impact may be an amount of change to a construction project's schedule. In an example, the typical or expected amount of schedule impact may be derived based on historical data showing linkage between data objects and change orders. Furthermore, similar to the example discussed above related to a typical or expected amount of effort spent on an action item, a typical or expected amount of schedule impact could be represented at a project level or at a per-action-item level.

As another possibility, a per-budget-code metric for a given budget code may take the form of a typical or expected likelihood of an action item maturing into a change event. In this regard, back-end computing platform 102 may, for each budget code, identify the typical or expected likelihood of an action item maturing into a change event. In general, a change event may be any event resulting in a modification that affects the scope of work on a construction project and the project's schedule and/or cost(s). For instance, a change event may be an event that affects the original scope of a construction project. Additionally or alternatively, a change event can also be an event that causes a change to the project schedule or results in unexpected costs. In an example, the typical or expected likelihood of an action item maturing into a change event may be derived based on historical data showing linkage between data objects and change orders. Furthermore, similar to the example discussed above related to a typical or expected amount of effort spent on an action item, a typical or expected likelihood of an action item maturing into a change event could be represented at a project level or at a per-action-item level.

As another possibility, a per-budget-code metric for a given budget code may take the form of a typical quantity of action items that are outstanding at each of various different points or stages within the project's timeline. In this regard, back-end computing platform 102 may, for each budget code, identify a typical quantity of action items that are outstanding at each of various different points or stages within the project's timeline. The typical quantity may, for instance, be an average number of action items that occur at different points or stages within a project's timeline or a group of projects' timelines. The different points or stages within the project's timeline may be defined in various ways. As one possibility, the different points or stages within the project's timeline may be defined based on a predefined percentage of completion of the construction-related activity for the construction projects (e.g., 25%, 50%, 75%, and/or 100% complete), among other possibilities. Other examples are possible as well.

As another possibility, a per-budget-code metric for a given budget code may take the form of a relation of action items for a budget code and their likelihood to lead to one or more incidents (e.g., a safety incident and/or a quality incident). In this regard, back-end computing platform 102 may, for each budget code, identify a relative likelihood that an action item could be associated with a future safety incident based on the budget code or a future quality incident based on the budget code. As a representative example, back-end computing platform 102 may analyze whether, if there are electrical RFIs that are not addressed within a certain time period, that potentially leads to an increase in safety incidents. In addition, in an example, back-end computing platform 102 may analyze whether the overall financial impact of a safety incident(s) is greater for electrical-related safety incidents versus mechanical-related safety incidents.

As another possibility, a per-budget-code metric for a given budget code may take the form of an indication of whether the point or stage within the project's timeline at which an action item occurs relates to a likelihood of schedule impact or cost impact. For example, a metric may reflect whether an action item for a given budget code has a different likelihood of schedule and/or cost impact at different stages of project completion. For instance, a metric may reflect that, if an action item for a given budget code occurs at first stage (e.g., at 20%-40% project completion), the action item for the given budget code is less likely to have a cost or schedule impact compared to a situation where the action item for the given budget code occurs at a second stage (e.g., 60%-80% project completion).

In some examples, a per-budget-code metric for a given budget code may reflect given topics linked to that given budget code. For instance, the metric may be that action items on a per-budget code basis are usually divided amongst a plurality of topics and/or divided in given proportions amongst the plurality of topics. In this regard, in an example, back-end computing platform 102 may be configured to further evaluate data objects so as to further divide action items linked to budget codes (e.g., using a topic-modeling machine learning technique) into topics. In this regard, various topics are possible and may be defined in various manners, and in at least some implementations, the topics may correspond to (i) different categories of labor and/or materials associated with the budget code and/or (ii) different categories of conflicts that may be involved in a construction project, examples of which include Utility Conflict (e.g., multiple utilities hitting each other in the design, a wall or ceiling interfering with one or more utilities and needs to be moved, etc.), a Personnel Conflict (e.g., personnel on project being overwhelmed and/or overworked, a conflict between different parties on construction project, a professionalism issue, etc.), and/or a Supply Chain Conflict (e.g., requests to substitute one product for another either due to cost or availability concerns), among other possibilities. Other topics are possible as well.

In addition to the example historical metrics discussed above, other historical metrics are possible as well.

Further, in some examples, back-end computing platform 102 may be configured to periodically update the historical metrics. Back-end computing platform 102 may update the historical metrics in various ways. As one possibility, back-end computing platform 102 may perform operations 502-506 with respect to an updated set of data objects. For instance, back-end computing platform 102 may, at block 502 obtain an updated set of data objects and then perform the functions of blocks 504 and 504 for the updated set of data objects. Other examples are possible as well.

B. Insights Phase

As mentioned above, in accordance with the disclosed technology, there may be an “insights” phase that involves using the per-budget-code metrics and/or the data science model(s) to provide insights to users. Various examples of back-end computing platform 102 using the per-budget-code metrics and/or the data science model(s) to provide insights to users are discussed in greater detail in the following subsections.

1. Insights Based at least on Historical Per-Budget-Code Metrics

After generating budget-code-specific metrics for the two or more budget codes, back-end computing platform 102 may use these generated budget-code-specific metrics to derive construction-related insights. In general, any suitable insight may be generated based at least on the identified budget-code-specific metrics for the two or more budget codes. Further, in some examples, the one or more insights may be insights that are independent of any particular ongoing construction project that has data objects representing outstanding action items to be resolved for the construction project (e.g., general insights for planning one or more future construction projects), and in other examples the one or more insights may be insights that are specific to a particular ongoing construction project (e.g., insights for planning the ongoing project and/or managing outstanding action items associated with the ongoing construction project).

FIG. 5B depicts one example of a process 520 that may be carried out in accordance with the disclosed technology for determining one or more construction-related insights and presenting the one or more construction-related insights to a user. For purposes of illustration only, example process 520 is described as being carried out by back-end computing platform 102 of FIG. 1, but it should be understood that example process 520 may be carried out by computing platforms that take other forms as well. Further, it should be understood that, in practice, the functions described with reference to FIG. 5B may be encoded in the form of program instructions that are executable by one or more processors of back-end computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

For instance, as shown in FIG. 5B, at block 522, back-end computing platform 102 determines one or more construction-related insights based at least on the identified budget-code-specific metrics for the two or more budget codes. In general, determining one or more construction-related insights based at least on the identified budget-code-specific metrics may involve determining the one or more construction-related insights using one or more of the identified budget-code-specific metrics. Further, further, as mentioned above, the insights may be independent of any particular ongoing construction project or specific to a particular ongoing construction project.

(a) Insights Independent of any Particular Ongoing Project

Turning first to construction-related insights that are independent of any particular ongoing construction project that has outstanding action items to be resolved for the construction project, various construction-related insights that are independent of any particular ongoing construction project are possible.

As one possibility, an insight may be based on how much effort (e.g., time) has historically been spent on action items (and perhaps also when that effort has historically been spent). Back-end computing platform 102 may derive such an insight in various ways. For instance, back-end computing platform 102 may, on a per-budget-code basis, evaluate how much effort has historically been spent on action items represented by data objects mapped to the budget code (and perhaps also when that time/effort has historically been spent). Back-end computing platform 102 may then compare that historical effort to an amount of budget allocated to the budget code to determine whether it is comparable or out of balance and then use that comparison to make a suggestion(s) for a new or future project. As a representative example, one example insight may be a suggestion regarding an adjustment related to how and/or when action items related to that budget code are handled. As another example, in a scenario where there are a large number of RFIs surrounding electrical drawings creating an imbalance of responding to RFIs versus the budget allocated to an electrical budget code, then one insight may be a suggestion of earlier diligence with the electrical drawings to avoid costly time spent later.

As another possibility, an insight may be based on the typical or expected timing when action items arise within project timeline (and also perhaps on an amount of overall construction budget to which the given budget code is associated). As a representative example, one example insight may be that, even if there are action items represented by data objects mapped to a given budget code that is associated with a threshold low percentage (e.g., less than a given amount, such as less than 1%, 2%, 3%, 4%, or 5%, among other possibilities) of overall construction-project budget, these action items typically occur at a given point or stage of a construction project (e.g., late in construction project) and thus are costly. As a particular illustrative example, a budget code of lighting fixtures may be a threshold low percentage of overall construction-project budget (e.g., less than 5%), but action items represented by data objects mapped to lighting fixtures may typically occur late in a construction project. Therefore, these action items related to light fixtures may be costly. The example insight may further comprise a suggestion to resolve action items represented by data objects mapped to this budget code quickly and/or address at design phase so as to reduce the number of action items represented by data objects mapped to this budget code. As another representative example, an insight may be that resolving action items for one or more specific budget codes earlier can lead to reductions in overall cost, schedule issues, and/or safety incidents.

As yet another possibility, an insight may be based on the typical or expected amount of time to close an action item. Back-end computing platform 102 may derive such an insight in various ways. For instance, back-end computing platform 102 may, on a per-budget-code basis, evaluate the typical or expected amount of time to close an action item. In an example, back-end computing platform 102 may then compare that historical typical or expected amount of time to an amount of budget allocated to the budget code and then use that comparison to make a suggestion(s) for a new or future project. As a representative example, one example insight may be a suggestion that, if “time to close” is long for action items represented by data objects having a budget code associated with a threshold high percentage of overall construction-project budget (e.g., higher than a given amount, such as higher than 10%, among other possibilities), consider reducing “time to close” for those action items (e.g., assign high priority to those action item(s)). As another representative example, and in particular with reference to RFI data objects, one example insight may be a suggestion that, for a given budget code, if the time to close action items associated with RFIs is reduced from a first given number of days (e.g., 10 days) to less than a second given number of days (e.g., less than 7 days), the overall budget impact of those RFIs tends to be reduced by a given percentage (e.g., 10%), where budget impact is measured by magnitude of change orders versus amount of budget allocated to the budget code. As another representative example, in some scenarios, work may not proceed until an RFI is answered (and the action item is closed). In such scenarios, every day an RFI is not answered may amount to time that work is delayed. Further, if the importance of work is correlated with the budget for that work, then this may reveal that the cost is higher to not address certain types of RFIs over others. In such scenarios, an example insight may be a suggestion that, in general, one should prioritize focusing on reducing the occurrence of certain RFIs over others. As yet another representative example, an insight may be that reducing the time to close action items for one or more specific budget codes can lead to reductions in overall cost, schedule issues, and/or safety incidents.

As still yet another possibility, an insight may be based on the typical or expected likelihood of an action item maturing into a change event. As a representative example, one example insight may be that given budget codes are linked to higher probability of change events than others (e.g., action items represented by data objects mapped to a given budget code have a threshold high link to change orders, which may have high schedule and/or budget impact). The example insight may further comprise a suggestion to resolve action items represented by data objects mapped to this budget code quickly and/or address at design phase so as to reduce the number of action items represented by data objects mapped to this budget code.

As still yet another possibility, an insight may be based on the typical quantity of action items per budget code. Back-end computing platform 102 may derive such an insight in various ways. For instance, back-end computing platform 102 may determine that, historically, a set of construction projects (e.g., projects for this organization, projects of similar category, etc.) have this typical quantity of action items per budget code. As a representative example, one example insight may be that, for a new or future construction project, on a per budget code basis, one may expect this number of action items for that budget code throughout the new or future project.

As still yet another possibility, an insight may be based on a likelihood of action items for a given budget code to lead to one or more incidents (e.g., a safety incident and/or a quality incident). As a representative example, back-end computing platform 102 may determine that historically certain action items associated with observation data objects are more likely to lead to safety incidents when they are left unaddressed for an extended period of time. In such a scenario, an example insight may be a suggestion that, if the action items associated with the observation data objects are addressed in less than a given number of days (e.g., less than 5 days), then there may be a given percentage (e.g., 20%) less likelihood to have a safety incident. Other examples are possible as well.

As still yet another example, an insight may be based on given topics linked to a given budget code. As a representative example, an insight may be that action items on a per-budget code basis are usually divided in this proportion amongst these topics. As another representative example, back-end computing platform 102 may determine that historically action items associated with a specific topic(s) within a budget code are more likely to be associated with issues compared to action items associated with other topics within that budget code. In such a scenario, an example insight may be to address action items associated with the specific topic(s) more quickly than action items associated with the other topics. Other examples are possible as well.

As still yet another example, an insight may be based on linking (i) time to close an action item to (ii) profit, cost, and/or incidents associated with a construction project. For instance, back-end computing platform 102 may determine that addressing certain action items associated with certain budget codes within a given time period leads to one or more desirable outcomes, such as more profitability at an end of a project, fewer safety incidents, and/or fewer quality incidents, among other possibilities. In such a scenario, an example insight may be to address given action items associated with given budget codes within a given time period so as to achieve more profitability at the end of a project, fewer safety incidents, and/or fewer quality incidents.

Other example insights that are independent of any particular ongoing construction project that has outstanding action items to be resolved for the construction project are possible as well.

(b) Insights Specific to Ongoing Project

Turning next to construction-related insights specific to a particular ongoing construction project, these construction-related insights specific to a particular ongoing construction project may take various forms.

As one possibility, construction-related insights specific to a particular ongoing construction project may take the form of a recommended prioritization of outstanding action items for the particular ongoing construction project. Back-end computing platform 102 may derive recommended prioritization of outstanding action items in various ways. For instance, in an example, in order to determine insights are specific to a particular ongoing construction project, back-end computing platform 102 may (i) apply the data science model(s) to data objects for current/outstanding action items on an ongoing project and then (ii) use budget-code mappings and/or per-budget-code metrics to help prioritize outstanding action items for the ongoing project.

As mentioned above, the historical metrics may be derived based on analysis of a given set of data objects. In order to determine budget-code mappings for outstanding action items for the ongoing project, back-end computing platform 102 may obtain a second set of data objects, wherein each data object of the second set represents a respective outstanding action item for the ongoing construction project. Back-end computing platform 102 may then evaluate the obtained second set of data objects and thereby identify two or more budget-code-specific subsets of data objects of the second set, where each respective budget-code-specific subset of data objects of the second set corresponds to a respective one of two or more budget codes. Further, back-end computing platform 102 may determine, based at least on the identified historical budget-code-specific metrics and the two or more budget-code-specific subsets of data objects of the second set, a prioritization of the outstanding action items for the ongoing construction project.

Various examples of prioritizing outstanding action items for the ongoing construction project using budget-code mappings and per-budget-code metrics are possible. In one example of prioritizing action items using budget-code mappings and per-budget-code metrics, back-end computing platform 102 may, after predicting mappings of current data objects, (1) access previously-derived historical metrics indicating an amount of time/effort that is needed to resolve action items for each budget code, (2) compare that amount against amount of budget for the ongoing construction project that is allocated for that budget code, and (3) identify inconsistencies (e.g., budget codes where amount of time/effort needed to resolve action items is significantly greater than amount of budget allocated for that budget code), and thereafter use that data to prioritize the outstanding action items for the ongoing construction project. As a representative example, historical metrics may reveal that the typical amount of time/effort needed to resolve action items represented by data objects mapped to a given budget code (e.g., RFIs mapped to lighting fixtures), and the given budget code (e.g., lighting fixtures) may only account for a small portion of overall construction-project budget for the ongoing project (e.g., less than 1%). In such a scenario, one example insight may be a suggestion to de-prioritize spending time on these action items represented by RFIs mapped to lighting fixtures in favor of addressing other open action items represented by data objects mapped to other budget codes. As another representative example, historical metrics may reveal that a given budget code is linked to an RFI that has a long time-to-close metric, and the given budget code may be associated with a threshold high percentage (e.g., higher than a given amount, such as higher than 10%, among other possibilities) of overall construction-project budget for the ongoing project. In such a scenario, one example insight may be to prioritize the action item associated with this RFI.

In another example of prioritizing action items using budget-code mappings and per-budget-code metrics, back-end computing platform 102 may, after predicting mappings of current data objects, access previously-derived historical metrics indicating typical or expected amount of budget impact for each budget code and use that data to prioritize the outstanding action items for the ongoing construction project. As a representative example, one example insight may be that outstanding action items are prioritized from highest budget impact to lowest budget impact.

In another example of prioritizing action items using budget-code mappings and per-budget-code metrics, back-end computing platform 102 may, after predicting mappings of current data objects, access previously-derived historical metrics indicating typical or expected amount of schedule impact for each budget code and use that data to prioritize the outstanding action items for the ongoing construction project. As a representative example, one example insight may be that outstanding action items are prioritized from highest schedule impact to lowest schedule impact.

In another example of prioritizing action items using budget-code mappings and per-budget-code metrics, back-end computing platform 102 may, after predicting mappings of current data objects, (1) access previously-derived historical metrics indicating typical or expected timing when action items arise within project timeline, (2) identify budget codes having a typical or expected timing when action items arise within project timeline that is prior to the current point in time within the ongoing project's timeline, and (3) prioritize action items represented by data objects mapped to the identified budget codes.

In another example of prioritizing action items using budget-code mappings and per-budget-code metrics, back-end computing platform 102 may, after predicting mappings of current data objects, (1) access previously-derived historical metrics indicating, for each budget code, the typical or expected likelihood of action item maturing into a change event, (2) identify budget codes having a threshold likelihood of action item maturing into a change event, and (3) prioritize action items represented by data objects mapped to the identified budget codes. As a representative example, one example insight may be that a given budget code may have a threshold likelihood of an action item (e.g., greater than 50%, among other possibilities) maturing into a change event (which may have high schedule and/or budget impact). The example insight may further comprise a suggestion to resolve action items represented by data objects mapped to this budget code quickly and/or address at design phase so as to reduce the number of action items represented by data objects mapped to this budget code). As another representative example, there may be a budget code where action items associated with RFIs have a high likelihood of leading to change orders and this budget code may be a relatively high percentage of the overall budget, which may in turn create change orders that have a large impact on the budget. Since these impacts will be more significant if they happen (compared to, e.g., action items for other budget codes that have a lower percentage of overall construction budget), an example insight may be a suggestion to address these action items as early as possible to avoid even more costly delays, budget impacts, and/or complications.

Other examples of prioritizing action items using budget-code mappings and per-budget-code metrics are possible as well. In some examples, prioritizing certain action items first may lead to a reduction in the number of overall action items to be addressed on a given construction project. In practice, the sequence of addressing action items may affect the number of new action items that may arise and prioritizing certain action items before others may reduce or avoid potential new action items. For instance, as an illustrative example, a scenario may exist where addressing RFI A before RFI B may typically lead to an RFI C being raised (which in turn would have been answered by responding to RFI B). In such a scenario, if RFI B had been answered prior to answering RFI A, then RFI C would not have arisen and there would not be further action to take. As a particular example, if RFI B is an electrical RFI and RFI A is a lighting-fixture RFI, then by responding to RFI A first one may get a follow-up electrical RFI C that is similar to RFI B, but specific to the lighting fixtures. On the other hand, if electrical RFI B is answered prior to lighting fixture RFI A, then follow-up electrical RFI C may be avoided.

As another possibility, construction-related insights specific to a particular ongoing construction project may take the form of an insight related to action items that do not exist for the current project but are expected to arise (e.g., based on historical metrics). Back-end computing platform 102 may derive such an insight in various ways. As a representative example, back-end computing platform 102 may apply data science model 400 to data objects for outstanding action items on an ongoing project and then compare (i) the extent of action items for different budget codes that exist at the current point within the project's timeline/schedule to (ii) the typical or expected timing when action items arise within project timeline, so as to determine whether there are budget codes for which you would expect to have seen action items but have not yet seen action items. As a representative example, one example insight may be that, for a given budget code, there would typically have been more action items, and therefore one may wish to investigate why such action items have not been occurring for the particular ongoing construction project.

Other example construction-related insights specific to a particular ongoing construction project are possible as well.

Returning to FIG. 5B, at block 524, back-end computing platform 102, back-end computing platform 102, transmits, to a client station, data defining the one or more construction-related insights and thereby causes an indication of the one or more construction-related insights to be presented at a user interface of the client station. The indication of the one or more construction-related insights may be presented in any suitable manner. For instance, the indication of the one or more insights to be presented at the user interface of the client station may take various forms, including a textual representation and/or graphical representation of the one or more insights, among other possibilities.

2. Insights Based at least on Budget-Code Specific Subsets of Data Objects

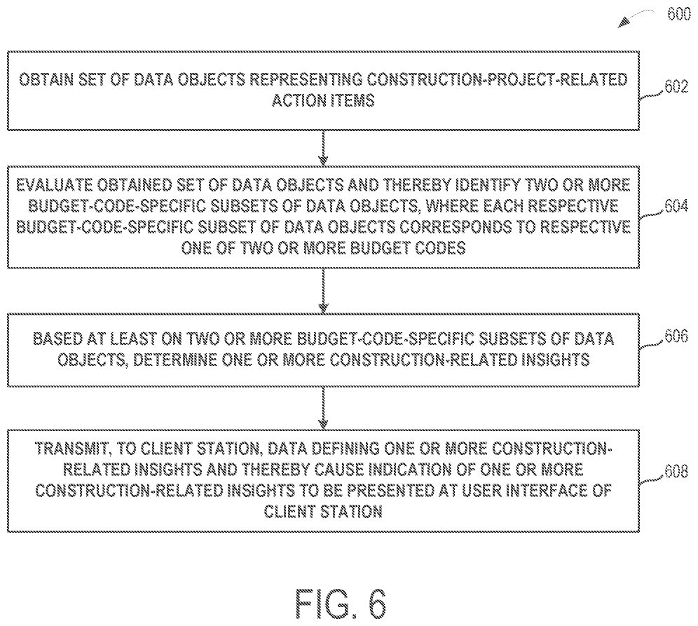

Another example method in accordance with the present disclosure is described with reference to FIG. 6. In particular, FIG. 6 depicts one example of a process 600 that may be carried out in accordance with the disclosed technology in order to facilitate determination of one or more construction-related insights based at least on identified budget-code-specific subsets of data objects. For purposes of illustration only, example process 600 is described as being carried out by back-end computing platform 102 of FIG. 1, but it should be understood that example process 600 may be carried out by computing platforms that take other forms as well. Further, it should be understood that, in practice, the functions described with reference to FIG. 6 may be encoded in the form of program instructions that are executable by one or more processors of back-end computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

For instance, as shown in FIG. 6, at block 602, back-end computing platform 102 obtains a set of data objects representing construction-project-related action items. These data objects may be data objects for an ongoing construction project that represent outstanding action items. Block 602 is similar in many respects to block 502 (noting, however, that in an example the set of data objects differs in that the set of data objects obtained at block 602 is a set of data objects for a given ongoing construction project), and thus is not described in as great of detail. It should be understood, however, that many of the possibilities and permutations described with respect to block 502 are also possible with respect to block 602.

At block 604, back-end computing platform 102 evaluates the obtained set of data objects and thereby identifies two or more budget-code-specific subsets of data objects, where each respective budget-code-specific subset of data objects corresponds to a respective one of two or more budget codes. Block 604 is similar in many respects to block 504 (noting, however, that in an example the set of data objects evaluated differs in that the set of data objects evaluated at block 602 is a set of data objects for the given ongoing construction project), and thus is not described in as great of detail. It should be understood, however, that many of the possibilities and permutations described with respect to block 504 are also possible with respect to block 604.

At block 606, back-end computing platform 102 determines, based at least on the two or more budget-code-specific subsets of data objects, one or more construction-related insights. In some situations, determining the one or more construction-related insights based at least on the two or more budget-code-specific subsets of data objects involves determining the one or more construction-related insights without using any of the historical metrics. In other situations, determining the one or more construction-related insights based at least on the two or more budget-code-specific subsets of data objects involves determining the one or more construction-related insights based on the two or more budget-code-specific subsets of data objects and the historical metrics.

Turning to situations where determining the one or more construction-related insights based at least on the two or more budget-code-specific subsets of data objects involves determining the one or more construction-related insights without using any of the historical metrics, in some examples, the one or more construction-related insights may be based on the two or more budget-code-specific subsets of data objects and the budget for the ongoing construction project. For instance, back-end computing platform 102 may, after predicting mappings of current data objects, assign prioritization to outstanding action items based on amount of budget allocated for each budget code (e.g., action items represented by data objects mapped to higher-value budget codes get assigned higher priority). As a representative example, one example insight may be, for action items represented by data objects mapped to a given budget code that is associated with a threshold low percentage of overall construction-project budget for the ongoing project, assign low priority to the action items.

As another representative example, a scenario may exist for a given construction project where the project has outstanding action items including (1) a first action item corresponding to a concrete RFI data object, (2) a second action item corresponding to an electrical RFI data object, (3) a third action item corresponding to a metal observation data object, and (4) a fourth action item corresponding to an electrical observation data object. Further, the given construction project may have a budget where the amount of budget allocated for metals is greater than the amount of budget allocated for concrete, which in turn is greater than the amount of budget allocated for electrical (i.e., metals>concrete>electrical). Still further, for this given construction project, some action items may take priority over others such as, in general for this given project, action items associated with RFIs are more important than action items associated with observations. However, the magnitude of the budget may further affect the prioritization of action items, so an example insight may be to address the action items in the following order of priority: (1) the third action item corresponding to a metal observation data object: (2) the first action item corresponding to a concrete RFI data object; (3) the second action item corresponding to an electrical RFI data object; and (4) the fourth action item corresponding to an electrical observation data object. Another example insight may be to assign the first, second and third action items a priority level of “1” and the fourth action item a lower priority level of “2”. Other examples are possible as well.

In other examples, the one or more construction-related insights may be based on the two or more budget-code-specific subsets of data objects and project-related impact predictions (which are described in greater detail in the following subsection). Other examples of determining the one or more construction-related insights without using any of the historical metrics are possible as well.

Turning next to situations where determining the one or more construction-related insights based at least on the two or more budget-code-specific subsets of data objects involves determining the one or more construction-related insights based on the two or more budget-code-specific subsets of data objects and the historical metrics, the one or more construction-related insights based at least on the two or more budget-code-specific subsets of data objects may take various forms. In this regard, determining the one or more construction-related insights based at least on the two or more budget-code-specific subsets of data objects is similar in many respects to determining insights for ongoing construction projects as discussed above with respect to block 522, and thus is not described in as great of detail. It should be understood, however, that many of the possibilities and permutations described with respect to determining insights for ongoing construction projects as discussed above with respect to block 522 are also possible with respect to block 606.

As mentioned above, at block 604, the two or more budget-code-specific subsets of data objects are identified based on an evaluation of a given set of data objects, such as a set of data objects for the given ongoing construction project. In an example, in order to, at block 606, determine the one or more construction-related insights based on the two or more budget-code-specific subsets of data objects and the historical metrics, back-end computing platform 102 may evaluate obtain a second set of data objects representing construction-project-related action items (e.g., such as the set of data objects obtained at block 502 of FIG. 5A). Back-end computing platform 102 may evaluate the obtained second set of data objects and thereby identify two or more budget-code-specific subsets of data objects of the second set, where each respective budget-code-specific subset of data objects of the second set corresponds to a respective one of two or more budget codes. Back-end computing platform 102 may then, for each respective one of the two or more budget codes, evaluate the respective budget-code-specific subset of data objects of the second set and thereby identify one or more budget-code-specific metrics for the respective one of the two or more budget codes. Back-end computing platform 102 may then determine the one or more construction-related insights based on the two or more budget-code-specific subsets of data objects (from the given set of data objects) and the historical metrics (derived based on the second set of data objects).

Returning to FIG. 6, at block 608, back-end computing platform 102 transmits, to a client station, data defining the one or more construction-related insights and thereby causes an indication of the one or more construction-related insights to be presented at a user interface of the client station. The indication of the one or more construction-related insights may be presented in any suitable manner. For instance, the indication of the one or more insights to be presented at the user interface of the client station may take various forms, including a textual representation and/or graphical representation of the one or more insights, among other possibilities.

3. Insights Based at least on Project-Related Impact Predictions Related to Data Objects

In accordance with the present disclosure, in addition to or alternative to determining construction-related insights related to ongoing construction projects based on historical budget-code-specific metrics and/or budget-code classification of data objects for an ongoing project that represent outstanding action items, construction-related insights related to ongoing construction projects may also be determined based on project-related impact predictions for data objects representing construction-project-related action items.

In this regard, in addition to back-end computing platform 102 being configured to analyze data objects representing outstanding construction-project-related action items of an ongoing construction project to identify budget-code specific subsets of those data objects, back-end computing platform 102 may also be configured to further analyze those data objects to predict project-related impact predictions for the data objects. Project-related impact predictions may take various forms. In an example, the project-related impact predictions may take the form of an amount of budget impact, an amount of schedule impact, and/or a likelihood of a change event related to the data objects.

Back-end computing platform 102 may then use those predictions (perhaps in conjunction with the historical per-budget-code metrics and/or budget-code classification of data objects for an ongoing project that represent outstanding action items) to prioritize outstanding action items represented by the data objects. For instance, in some examples, prioritization of outstanding action items represented by a set of data objects may be based on the project-related impact predictions of data objects in the set of data objects, budget-code classification of data objects in the set of data objects, and historical per-budget-code metrics (derived from a different set of historical data objects). In other examples, the project-related impact predictions for the data objects may be used as a sole basis for prioritization of outstanding action items represented by the data objects.

Deriving the impact predictions may take various forms. For instance, within examples, in addition to the budget-code data science model(s) discussed above, the system may include one or more other data science models for outputting these additional predictions that can be used to prioritize action items represented by the data objects for ongoing projects.

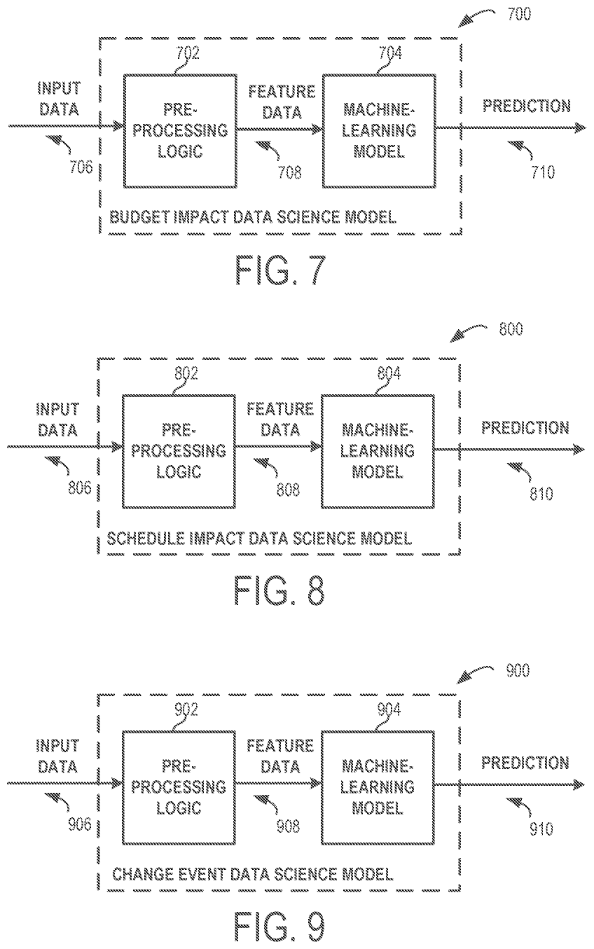

As one possibility, back-end computing platform 102 may create and/or deploy one or more data science models configured to predict amounts of budget impact for data objects. At a high level, a data science model configured to predict amounts of budget impact for data objects may take data for a given data object as input and output a predicted budget impact for that given data object. FIG. 7 depicts a conceptual illustration of one example of a data science model 700 for predicting amounts of budget impact for data objects in accordance with the present disclosure. As shown in FIG. 7, the data science model 700 may comprise pre-processing logic 702 and a machine-learning model 704. The pre-processing logic 702 may function to (i) receive input data 706 for a given data object that represents a given project-related action item and (ii) transform the input data 706 for the given data object into feature data 708 for the given data object, which is then provided as input to the machine-learning model 704. In turn, the machine-learning model 704 may comprise any trained model object that is configured to (i) receive the feature data 708 for the given data object as input, (ii) evaluate the feature data 708 for the given data object, and (iii) based on the evaluation of the feature data, determine and output prediction 710 that takes the form of a predicted amount of budget impact for that data object. The predicted amount of budget impact for that data object may take various forms, such as a predicted amount of budget impact in terms of an amount of money.

Back-end computing platform 102 may apply data science model 700 to current data objects for the ongoing project to identify predicted budget impacts for the data objects. In turn, back-end computing platform 102 may use the predicted budget impacts (perhaps in conjunction with the historical per-budget-code metrics and/or budget-code classification of data objects for an ongoing project that represent outstanding action items) to prioritize the action items represented by the data objects.

The one or more data science models for predicting an amount of budget impact may be created and function in a manner similar to that as described above with respect to data science model 400, and thus is not described in as great of detail. It should be understood, however, that many of the possibilities and permutations described with respect to the creation and function of data science model 400 are also possible with respect to the one or more data science models for predicting an amount of budget impact. For instance, in an example, pre-processing logic 702 may take the form of NLP techniques that analyze data values associated with the data object and translate input data 706 into feature data 708 having an appropriate form for input into machine-learning model 704. Further, in an example, machine-learning model 704 takes the form of a regression model that outputs prediction 710.

As another possibility, back-end computing platform 102 may create and/or deploy one or more data science models configured to predict amounts of schedule impact for data objects. At a high level, a data science model configured to predict amounts of schedule impact for data objects may take data for a given data object as input and output a predicted schedule impact for that given data object. FIG. 8 depicts a conceptual illustration of one example of a data science model 800 for predicting amounts of schedule impact for data objects in accordance with the present disclosure. As shown in FIG. 8, the data science model 800 may comprise pre-processing logic 802 and a machine-learning model 804. The pre-processing logic 802 may function to (i) receive input data 806 for a given data object that represents a given project-related action item and (ii) transform the input data 806 for the given data object into feature data 808 for the given data object, which is then provided as input to the machine-learning model 804. In turn, the machine-learning model 804 may comprise any trained model object that is configured to (i) receive the feature data 808 for the given data object as input, (ii) evaluate the feature data 808 for the given data object, and (iii) based on the evaluation of the feature data, determine and output prediction 810 that takes the form of a predicted amount of schedule impact for that data object. The predicted amount of budget impact for that data object may take various forms, such as a predicted amount of schedule impact in terms of number of days (or some other time metric).

Back-end computing platform 102 may apply data science model 800 to current data objects for the ongoing project to identify predicted schedule impacts for the data objects. In turn, back-end computing platform 102 may use the predicted schedule impacts (perhaps in conjunction with the historical per-budget-code metrics and/or budget-code classification of data objects for an ongoing project that represent outstanding action items) to prioritize the action items represented by the data objects.

The one or more data science models for predicting an amount of schedule impact may be created and function in a manner similar to that as described above with respect to data science model 400, and thus is not described in as great of detail. It should be understood, however, that many of the possibilities and permutations described with respect to the creation and function of data science model 400 are also possible with respect to the one or more data science models for predicting an amount of schedule impact. For instance, in an example, pre-processing logic 802 may take the form of NLP techniques that analyze data values associated with the data object and translate input data 806 into feature data 808 having an appropriate form for input into machine-learning model 804. Further, in an example, machine-learning model 804 takes the form of a regression model that outputs prediction 810.

As another possibility, back-end computing platform 102 may create and/or deploy one or more data science models configured to predict likelihoods of change events for data objects. At a high level, a data science model configured to predict likelihood of change events for data objects may take data for a given data object as input and output a likelihood of a change event for that given data object. FIG. 9 depicts a conceptual illustration of one example of a data science model 900 for predicting likelihoods of change events for data objects in accordance with the present disclosure. As shown in FIG. 9, the data science model 900 may comprise pre-processing logic 902 and a machine-learning model 904. The pre-processing logic 902 may function to (i) receive input data 906 for a given data object that represents a given project-related action item and (ii) transform the input data 906 for the given data object into feature data 908 for the given data object, which is then provided as input to the machine-learning model 904. In turn, the machine-learning model 904 may comprise any trained model object that is configured to (i) receive the feature data 908 for the given data object as input, (ii) evaluate the feature data 908 for the given data object, and (iii) based on the evaluation of the feature data, determine and output prediction 910 that takes the form of a predicted likelihood that an action item represented by the given data object will lead to change event. The predicted likelihood that an action item represented by the given data object will lead to a change event may take various forms, such as a percentage (or some other metric).

Back-end computing platform 102 may apply data science model 900 to current data objects for the ongoing project to identify predicted likelihoods of change events for the data objects. In turn, back-end computing platform 102 may use the predicted likelihoods of change events for data objects (perhaps in conjunction with the historical per-budget-code metrics) to prioritize the action items represented by the data objects.

The one or more data science models for predicting likelihoods of change events for data objects may be created and function in a manner similar to that as described above with respect to data science model 400, and thus is not described in as great of detail. It should be understood, however, that many of the possibilities and permutations described with respect to the creation and function of data science model 400 are also possible with respect to the one or more data science models for predicting likelihoods of change events for data objects. For instance, in an example, pre-processing logic 902 may take the form of NLP techniques that analyze data values associated with the data object and translate input data 906 into feature data 908 having an appropriate form for input into machine-learning model 904. Further, in an example, machine-learning model 904 takes the form of a regression model that outputs prediction 910.

Furthermore, in some examples, data science model 700, data science model 800, and data science model 900 may each be created using the historical metrics discussed above with respect to FIG. 5A. In this regard, for each data science model of models 700, 800, and 900, an initial (or “source”) dataset for a pool of historical data objects that is to be used to create the data science model may comprise the historical metrics. Other examples are possible as well.

Still further, while data science model 700, data science model 800, and data science model 900 are primarily described as being utilized to analyze current data objects for ongoing projects that have outstanding action items, in some examples, these data science models may also be used to analyze historical data objects for historical projects. In turn, back-end computing platform 102 may use project-related impact predictions (e.g., amount of budget impact, an amount of schedule impact, and/or a likelihood of a change event related to the data objects) for the historical data objects to generate construction-related insights that are independent of any particular ongoing construction project that has outstanding action items to be resolved for the construction project. For instance, project-related impact predictions for the historical data objects may reveal that, in general, data objects associated with certain budget codes are more likely to drive cost impacts, schedule impacts, and/or change events compared to data objects associated with other budget codes.

### 4. Example Display of Information Regarding One or More Construction-Related Insights

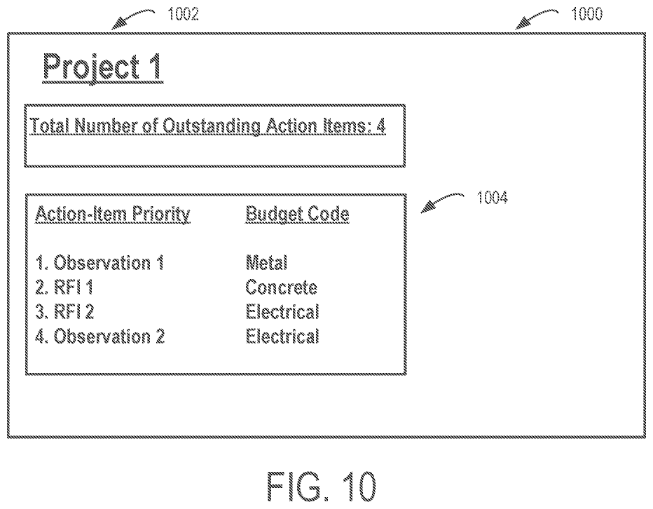

As mentioned above, the indication of the one or more construction-related insights may be presented in any suitable manner. For instance, the indication of the one or more insights to be presented at the user interface of the client station may take various forms, including a textual representation and/or graphical representation of the one or more insights, among other possibilities. FIG. 10 depicts an example snapshot 1000 of a GUI 1002 that displays information regarding an example one or more construction-related insights. GUI 1002 includes an indication 1004 of the one or more construction-related insights. In this example, the indication 1004 comprises an action-item priority list. Other examples are possible as well.

### IV. CONCLUSION

Example embodiments of the disclosed innovations have been described above. Those skilled in the art will understand, however, that changes and modifications may be made to the embodiments described without departing from the true scope and spirit of the present invention, which will be defined by the claims.

For instance, those in the art will understand that the disclosed operations for determining one or more construction-related insights using budget-code classifications may not be limited to only construction projects. Rather, the disclosed operations could be used in other contexts in connection with other types of projects as well.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
a network interface;
at least one processor;
a non-transitory computer-readable medium; and
program instructions stored on the non-transitory computer-readable medium that are executable by the at least one processor such that the computing platform is configured to:
obtain a set of data objects representing construction-project-related action items;
evaluate the obtained set of data objects and thereby identify two or more budget-code-specific subsets of data objects, where each respective budget-code-specific subset of data objects corresponds to a respective one of two or more budget codes;
for each respective one of the two or more budget codes, evaluate the respective budget-code-specific subset of data objects and thereby identify one or more budget-code-specific metrics for the respective one of the two or more budget codes;
based at least on the identified budget-code-specific metrics for the two or more budget codes, determine one or more construction-related insights; and
transmit, to a client station, data defining the one or more construction-related insights and thereby cause an indication of the one or more construction-related insights to be presented at a user interface of the client station.

2. The computing platform of claim 1, wherein the set of data objects representing construction-project-related action items is selected based on type of construction project.

3. The computing platform of claim 1, wherein the program instructions that are executable by the at least one processor such that the computing platform is configured to evaluate the obtained set of data objects and thereby identify two or more budget-code-specific subsets of data objects comprise program instructions that are executable by the at least one processor such that the computing platform is configured to:
for each data object of the obtained set of data objects, use one or more machine learning models to output, for each respective one of the two or more budget codes, a predicted likelihood that the data object corresponds to the respective budget code; and
based on the predicted likelihoods for the obtained set of data objects, identify two or more budget-code-specific subsets of data objects.

4. The computing platform of claim 1, wherein the one or more respective budget-code-specific metrics for the respective one of the two or more budget codes comprise one or more of:
an expected amount of effort spent on an action item associated with the respective one of the two or more budget codes;
an expected amount of time to close an action item associated with the respective one of the two or more budget codes;
an expected timing when action items associated with the respective one of the two or more budget codes arise within a project timeline;
an expected amount of budget impact of an action item associated with the respective one of the two or more budget codes;
an expected amount of schedule impact of an action item associated with the respective one of the two or more budget codes;
an expected likelihood of an action item associated with the respective one of the two or more budget codes maturing into a change event; and
a typical quantity of action items associated with the respective one of the two or more budget codes that are outstanding at each of various different stages within a project timeline.

5. The computing platform of claim 1, wherein each of the one or more construction-related insights is independent of any particular ongoing construction project.

6. The computing platform of claim 1, wherein each of the one or more construction-related insights is related to an ongoing construction project.

7. The computing platform of claim 6, wherein the one or more construction-related insights comprise a prioritization of outstanding action items for the ongoing construction project.

8. The computing platform of claim 6, further comprising program instructions stored on the non-transitory computer-readable medium that are executable by the at least one processor such that the computing platform is configured to:
obtain a second set of data objects, wherein each data object of the second set represents a respective outstanding action item for the ongoing construction project;
evaluate the obtained second set of data objects and thereby identify two or more budget-code-specific subsets of data objects of the second set, where each respective budget-code-specific subset of data objects of the second set corresponds to a respective one of two or more budget codes, and
wherein the program instructions that are executable by the at least one processor such that the computing platform is configured to, based at least on the identified budget-code-specific metrics for the two or more budget codes, determine one or more construction-related insights comprise program instructions that are executable by the at least one processor such that the computing platform is configured to:
based at least on the identified budget-code-specific metrics and the two or more budget-code-specific subsets of data objects of the second set, determine a prioritization of outstanding action items for the ongoing construction project.

9. The computing platform of claim 8, further comprising program instructions stored on the non-transitory computer-readable medium that are executable by the at least one processor such that the computing platform is configured to:
for each data object of the second set, evaluate the data object of the second set and thereby identify one or more project-related impact predictions related to the data object of the second set, and
wherein the program instructions that are executable by the at least one processor such that the computing platform is configured to, based at least on the identified budget-code-specific metrics and the two or more budget-code-specific subsets of data objects of the second set, determine a prioritization of outstanding action items for the ongoing construction project comprise program instructions that are executable by the at least one processor such that the computing platform is configured to:
based at least on the identified budget-code-specific metrics, the two or more budget-code-specific subsets of data objects of the second set, and the project-related impact predictions related to the data objects of the second set, determine the prioritization of outstanding action items for the ongoing construction project.

10. The computing platform of claim 9, wherein the one or more project-related impact predictions related to the data object of the second set comprise one or more of a predicted amount of budget impact for the data object, an amount of schedule impact for the data object, and a likelihood of a change event for the data object, and
wherein the program instructions that are executable by the at least one processor such that the computing platform is configured to, for each data object of the second set, evaluate the data object of the second set and thereby identify one or more project-related impact predictions related to the data object of the second set comprise program instructions that are executable by the at least one processor such that the computing platform is configured to:
for each data object of the second set, use one or more machine learning models to output, for the data object, the one or more of a predicted amount of budget impact for the data object, an amount of schedule impact for the data object, and a likelihood of a change event for the data object.

11. The computing platform of claim 6, wherein the one or more construction-related insights comprise an insight related to action items that do not currently exist for the ongoing construction project but are expected to arise.

12. The computing platform of claim 1, wherein each of the two or more budget codes is from a predefined group of potential budget codes.

13. The computing platform of claim 1, wherein the set of data objects representing construction-project-related action items comprises a plurality of types of data objects, wherein each type of data object comprises a given set of data fields that differs from the sets of data fields of other types of data objects.

14. A non-transitory computer-readable medium, wherein the non-transitory computer-readable medium is provisioned with program instructions that, when executed by at least one processor, cause a computing platform to:
obtain a set of data objects representing construction-project-related action items;
evaluate the obtained set of data objects and thereby identify two or more budget-code-specific subsets of data objects, where each respective budget-code-specific subset of data objects corresponds to a respective one of two or more budget codes;
for each respective one of the two or more budget codes, evaluate the respective budget-code-specific subset of data objects and thereby identify one or more budget-code-specific metrics for the respective one of the two or more budget codes;
based at least on the identified budget-code-specific metrics for the two or more budget codes, determine one or more construction-related insights; and
transmit, to a client station, data defining the one or more construction-related insights and thereby cause an indication of the one or more construction-related insights to be presented at a user interface of the client station.

15. The non-transitory computer-readable medium of claim 14, wherein the set of data objects representing construction-project-related action items is selected based on type of construction project.

16. The non-transitory computer-readable medium of claim 14, wherein the program instructions that, when executed by the at least one processor, cause the computing platform to evaluate the obtained set of data objects and thereby identify two or more budget-code-specific subsets of data objects comprise program instructions that, when executed by the at least one processor, cause the computing platform to:
for each data object of the obtained set of data objects, use one or more machine learning models to output, for each respective one of the two or more budget codes, a predicted likelihood that the data object corresponds to the respective budget code; and
based on the predicted likelihoods for the obtained set of data objects, identify two or more budget-code-specific subsets of data objects.

17. The non-transitory computer-readable medium of claim 14, wherein each of the one or more construction-related insights is independent of any particular ongoing construction project.

18. The non-transitory computer-readable medium of claim 14, wherein each of the one or more construction-related insights is related to an ongoing construction project.

19. A method carried out by a computing platform, the method comprising:
obtaining a set of data objects representing construction-project-related action items;
evaluating the obtained set of data objects and thereby identifying two or more budget-code-specific subsets of data objects, where each respective budget-code-specific subset of data objects corresponds to a respective one of two or more budget codes;
for each respective one of the two or more budget codes, evaluating the respective budget-code-specific subset of data objects and thereby identifying one or more budget-code-specific metrics for the respective one of the two or more budget codes;
based at least on the identified budget-code-specific metrics for the two or more budget codes, determining one or more construction-related insights; and
transmitting, to a client station, data defining the one or more construction-related insights and thereby causing an indication of the one or more construction-related insights to be presented at a user interface of the client station.

20. The method of claim 18, further comprising selecting the set of data objects representing construction-project-related action items based on type of construction project.
